(19) United States
(12) Patent Application Publication
(10) Pub. No.: US 2007/0040026 A1
(43) Pub. Date: Feb. 22, 2007

(54) Order processing apparatus and method

(75) Inventors: James Van Vleet, Fargo, ND (US); John Jasper, Arlington Heights, IL (US)

Correspondence Address: BRINKS HOFER GILSON & LIONE, P.O. BOX 10395, CHICAGO, IL, 60610, US

(73) Assignee: Verety, LLC

(21) Appl. No.: 11/528,819

(22) Filed: Sep. 26, 2006

Related U.S. Application Data
(63) Continuation of application No. 11/411,705, filed on Apr. 26, 2006.
(60) Provisional application No. 60/696,869, filed on Jul. 6, 2005.

(51) Int. Cl. G06K 15/00

(52) U.S. Cl. 235/383

(57) ABSTRACT

A remote order system includes at least one POS management system such as a restaurant management POS and one or more order taking points capable of entering orders. The one or more order taking points may include, for example, remote agent terminals, one or more remote order centers (ROC) and an order distributor. The RMPOS further includes drive-through order points, an order processing device and a POS system. The order processing device detects a customer presence signal corresponding with an arrival of a customer at a point of sale location and in response sends a destination request to the order distributor. The order distributor sends destination information to the order processing device and in response the order processing device establishes at least on\of: an audio link and/or a data link between the point of sale location and one of at least two point of sale order taking points.

### REFERENCE TO RELATED APPLICATIONS

This application is a continuation under 37 C.F.R. § 1.53(b) of U.S. patent application Ser. No. 11/411,705 filed Apr. 26, 2006 (Attorney Docket No. 12764/4) now U.S. Pat. No. ______, the entire disclosure of which is hereby incorporated by reference.

U.S. patent application Ser. No. 11/411,705 claims the benefit of the filing date under 35 U.S.C. § 119(e) of U.S. Provisional Application Ser. No. 60/696,869 filed Jul. 6, 2005, which is incorporated herein by reference.

### BACKGROUND

Retail stores are often in the business of selling inventory to individual customers, typically in a large number of small transactions. A typical transaction in a retail store may include several component-transactions, such as receiving one or more orders for goods and/or services, each particular order referred to as an order component, receiving payment for those goods and/or services, delivering the ordered goods and/or services or otherwise fulfilling the order, or a combination thereof. The point at which these transactions, or one or more of the component sub-transactions, take place is known as the point of sale (“POS”) location. In many retail environments the point of sale also serves as a point of order entry, the point of payment and/or the point of order fulfillment. For example, retail stores often integrate order entry points, i.e. POS terminals, such as integrated order input/cash registers, with a restaurant POS system (“RPOS” system), e.g. a system, typically including a network and server, which interconnects the POS terminals with displays or terminals in the production area to convey and track orders, etc. under the management of appropriate software. Orders are typically entered into the POS system from POS terminal, such as a cash register, inside the retail store. In other implementations, order entry, order payment and order fulfillment may occur at multiple different points/locations, as will be described below.

Exemplary retail stores include restaurants, such as a quick service restaurant,

a.k.a. fast food restaurant, where a customer may verbally convey their order to a cashier located at a counter inside the restaurant. Upon hearing the order, the cashier enters the order into the restaurant's POS system, also referred to as a restaurant POS system (“RPOS” system). The order is entered via a POS terminal, such as an integrated order input/cash register that calculates the total price and transmits the order to the kitchen staff. These POS terminal (often referred to as “point-of-sale registers”, or “POS registers”) often include custom hardware and/or software and, in a typical implementation, include simplified buttons or keys representing each of the various items offered for sale, i.e. a POS terminal interface. This simplified order entry interface streamlines, accelerates, as well as minimizes errors in, the order entry process. In this manner, the cashier/counter person, upon hearing a customer order a specific item, need only push the button or key corresponding to that item, thereby entering the specific item ordered in to the RPOS system and recording the corresponding price for totaling purposes. The customer then typically pays for the food and in response, the cashier/counter person delivers the food to the customer.

Typically, an RPOS system includes a POS server coupled with one or more POS terminals located at various POS locations throughout the restaurant and one or more kitchen video displays (“KVD”) and/or a kitchen video system (“KVS”) located in the production area. The POS server, POS terminals and KVD's are typically interconnected over a network, such as a local area network. The POS terminal typically relays the order, via the network and POS server, to a production display system, such as a KVD, so that kitchen staff may fill the order in a production area. For example, the POS terminal sends the order to the KVD in a grill area where kitchen staff view the order, cook and package the food. The RPOS system may track, via software loaded on the POS terminals and/or POS server, all incoming orders from each POS terminal, send orders to one or more production lines in the kitchen, load balance the orders amongst the productions lines and/or adapt to changes in orders. The kitchen staff may communicate with the RPOS system via a user interface, such as by pressing bump bar buttons on the KVD. For example, pressing bump bar buttons may indicate that an order is finished or that the display should be scrolled forward or backward.

Rather than place an order with a counter clerk at a POS terminal from within a restaurant, a customer may place their order from a remote POS location. For example, a remote POS location may be a drive-through order placement system, a computer based ordering kiosk or a telephone coupled, or otherwise in communication, with an order taker/cashier at a POS terminal within the restaurant via a dedicated connection. A drive-through POS location may include a speaker post and feature signage showing the restaurant menu, i.e. menu board. The cashier/order taker within the restaurant, upon hearing the order, may then enter the customer's order into the RPOS system via their POS terminal. For example, a customer may drive their car to a location proximate to the speaker post and menu board. The menu board lists the available items for order and their prices. An audio system connected to the speaker post allows two-way communication between the customer and the order taker/cashier located inside the building. Further, the audio system also may allow other staff in the restaurant to monitor the communication between the customer and the order taker/cashier. In response to the customer's verbal menu selections, the cashier enters the order into the POS terminal. The cashier verifies the customer's order and typically tells the customer the total amount owed. This arrangement provides the customer with the convenience of placing and picking up orders without leaving their car, and allows the restaurant to serve customers using two avenues: inside and drive-through. After placing their order and receiving their total, the customer drives to a window in the building where he may speak with the attendant face to face, pay the amount owed and subsequently receive their order.

While conventional drive-through order placement systems offer the advantages of customer convenience and increased product delivery channels, there are several disadvantages to such systems. First, the lack of adequately trained cashier/counter agents often leads to errors in taking orders. Such errors lead to customer irritation and annoyance and may further lead to, or compound with, other errors resulting in unacceptable delays in servicing customers and, potentially, lost customers, lost goodwill and lost revenue. Unfortunately, the labor pool for such establishments is shrinking at the same time that demand for such employees is increasing. Identifying, training, retaining and scheduling courteous and capable personnel is becoming one of the most critical concerns in the management of restaurants. This is particularly true in quick service/fast food restaurants. Such establishments emphasize the delivery of food in a consistent, timely and relatively inexpensive manner, while delivering consistently high quality products. Effective and capable employees are a prerequisite for achieving each of these goals.

With regards to a drive-thru POS location, mistakes in orders are often caused by unintelligible or inefficient communication through the speaker and microphone of the audio system, likely in conjunction with the noisy restaurant environment. For example, poor audio quality typically results in unintelligible orders causing inaccuracies in filling orders, thus creating inefficiencies in the ordering process. The audio quality is affected by, among other things, echo and noise. Further, speaker and microphone systems degrade due to exposure to outdoor elements, fatigue and/or improper use, further reducing audio quality. As a result, when the order taker cannot understand the customer's order or when the customer is unable to hear the order repeated back, the customer must repeat and/or confirm the order at the window when speaking face-to-face with the attendant. This causes a delay in taking the customer's order and further lowers customer satisfaction.

In addition, in some implementations, custom based hardware is used for the RPOS systems which does not allow for feasible hardware upgrades. For example, adding or improving the functionality of the custom based hardware often requires custom modification and custom upgrades to the hardware and/or software. Also, the custom based hardware is relatively expensive to procure and maintain compared to general purpose hardware such as readily available personal computers and components.

One exemplary remote order system is shown in U.S. Publication No. 2005/0049940, to Craig D. Tengler et al., entitled ORDER PROCESSING, published on Mar. 3, 2005 (“Tengler”). Tengler discloses remotely and centrally located order takers connected with drive-thru POS's using a conventional telephone network to initiate and implement the communications with the drivers while using a dedicated computer network to pass the completed orders back to the restaurant for fulfillment. By centralizing the in-take of orders, the Tengler system attempts to overcome the disadvantages related to adequately and efficiently staffing the order taking function without detracting from other operations of the restaurant. However, the disclosed system's reliance on a conventional telephone interconnection to initiate order processing limits the system's effectiveness in large scale operations resulting in inefficiencies at scale. In addition, the disclosed system fails to adequately handle errors in a seamless fashion, requiring manual recognition of a problem and manual intervention to deal with it, resulting in inefficient order handling and customer dissatisfaction. The disclosed system also fails to handle regional discrepancies in customer-order taker interactions resulting in further order handling inefficiencies and customer dissatisfaction. Further, the disclosed system fails to provide an adequate personal customer experience by which the customer is assured of a convenient and pleasing interaction, correct order placement and timely order fulfillment.

Ultimately, these and other disadvantages lead to, among other things, delays and inefficiencies in order intake and fulfillment. As a result, the ordering process, rather than the production process, becomes the critical bottle neck in the overall workflow. Delays in order intake then lead to reduced production, long customer queues and ultimately customer dissatisfaction.

### BRIEF DESCRIPTION OF THE DRAWINGS

The present invention is illustrated by way of example and not limitation in the accompanying figures, in which like reference numerals indicate similar elements, and in which:

FIG. 1 is a block diagram of one embodiment of an order processing system;

FIG. 2 is a block diagram of an alternate embodiment of an order processing system;

FIG. 3 is a block diagram of an order processing device according to one embodiment;

FIG. 4 is a block diagram of a remote order system according to one embodiment;

FIG. 5 is a block diagram of a point of sale management system according to one embodiment;

FIG. 6 is a flow chart of an order processing method according to one embodiment;

FIG. 7 is a block diagram of an order processing device according to one embodiment;

FIG. 8; is a block and diagram of dual tandem drive through configuration according to one embodiment; and

FIG. 9 is a flow chart of a method for electronic signal processing of audio signals according to one embodiment.

### DETAILED DESCRIPTION OF THE DRAWINGS AND PRESENTLY PREFERRED EMBODIMENTS

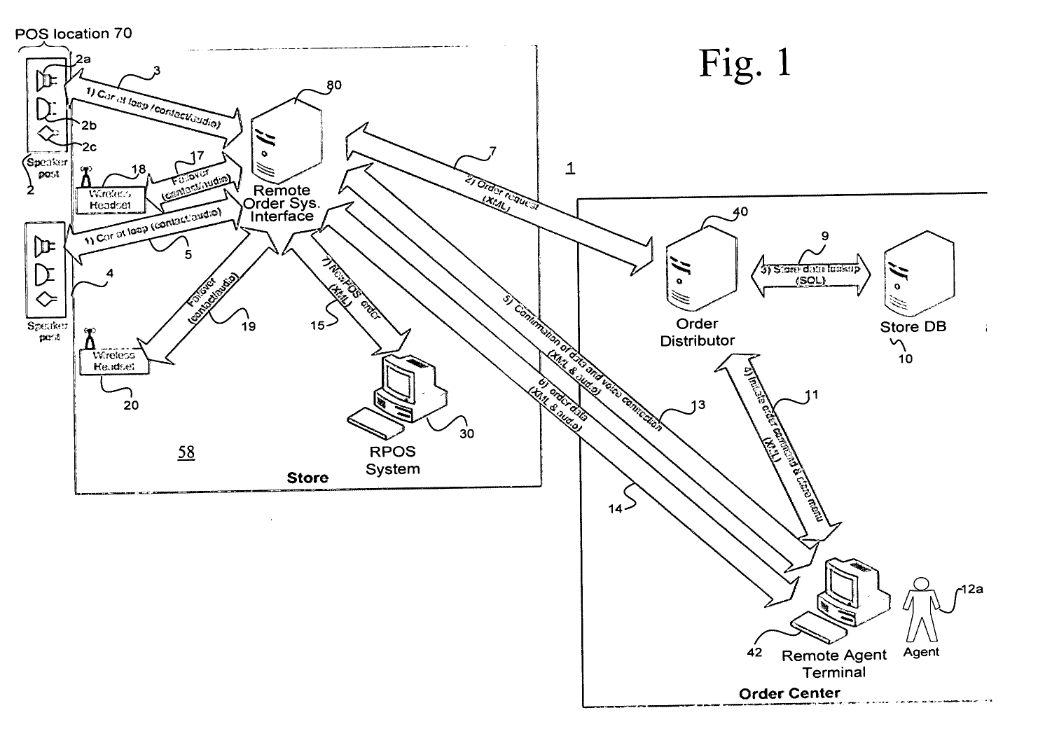

FIG. 1 shows a block diagram of a remote order processing system 1 according to one embodiment. The remote order processing system 1 facilitates order intake using remote order taking agents 12a which are located remotely from the point of sale, as will be described. The order processing system 1 is designed to accommodate a customer who places an order at a remote point of sale (“POS”) location 70 of a store or restaurant. The order may include one or more order components, i.e. one or more items, goods or services, that the user wishes to purchase, collectively or separately, during the present interaction/transaction. POS locations 70 include, for example, a POS location 70 located inside the store (not shown), such as a counter, or a remote POS location 70 which may be outside the store, such as along a drive-through lane which allows a customer to place, pay and receive fulfillment of an order without leaving their automobile. The POS location 70 is where a customer at least places an order, the order consisting of one or more order components, e.g. for one or more goods or services provided by the store or restaurant. Depending upon the implementation, the POS location may further include the point of payment, order fulfillment or some combination thereof. As described, the POS location 70 may feature a POS terminal (not shown) at which a counter clerk enters the order, in the case of a POS location 70 inside the store, or an order communication system in communication with someone who enters the order, as will be described below, in the case of a remote POS location 70, such as a drive through POS location 70.

As will be described with regards to one embodiment, an order taking session is initiated between a customer, located at a remote POS location 70, and a remote order taking agent 12a, located in a call center or elsewhere such as at their home, via the detection of the customer waiting to place an order at the remote POS location 70. This detection is communicated via a connectionless protocol to an order distributor 40 causing the distributor 40 to select a remote order taking agent 12a to handle the order. The actual communication session is then subsequently initiated, in response to the agent 12a being selected by the distributor, either by the selected remote order taking agent 12a with the remote POS location 70 or by the remote POS location 70 with the selected remote order taking agent 12a. Where the remote POS location 70 is associated with a particular menu out of a plurality of possible menus, the selected remote order taking agent 12a may be prompted with the particular menu associated with the remote POS location 70 prior to taking the order of the customer.

In an alternate embodiment which will be described, an order distributor 40 (a.k.a. Order Routing Engine), in response to being notified of a customer waiting to place an order at a particular remote POS location 70, selects a remote order taking agent 12a to handle the order and sends at least a notification thereto, the selection being based on, in one embodiment, a criteria other than only that the agent 12a is available to take the order, the other criteria including, such as for example, agent/customer compatibility, store/menu familiarity, demand, current store/queue status, etc.

In yet another alternative embodiment, a remote order communication system 1 is provided which is capable of electronically communicating a customer articulated/vocalized order, received from a customer at a remote POS location 70, to a remote order taking agent 12a located remote from the remote POS location 70 wherein the system 1 is further capable of automatically or manually processing the received vocalizations in order to enhance their intelligibility which may be at least partially unintelligible due to poor articulation by the customer, degraded equipment and/or interference with the communication.

In yet another alternative embodiment, the remote order system 1 is adapted for taking orders from a plurality of remote stores, each characterized by a particular menu, a promotion, or a combination thereof, the system 1 including a plurality of remote order taking agents 12a, each associated with a remote order taking terminal 42, wherein each remote order taking terminal 42 is capable of taking an order from each of the plurality of remote stores and further capable of dynamically prompting the remote order taking agent 12a with an interface comprising the menu, promotion or a combination thereof associated with the store from which the order is being taken. Alternatively, the remote order taking terminal 42 is capable of dynamically presenting a standardized prompt/interface to the remote order taking agent 12a representative of the menu, promotion or a combination thereof associated with the store from which the order is being taken, the presentation being similar for each menu, promotion or combination thereof for each store.

In yet another alternative embodiment, the remote order communication system 1 for taking orders from a plurality of remote stores includes a plurality of remote order taking agents 12a, each associated with a remote order taking terminal 42 capable of being coupled with an audio and/or visual interface located at each of the plurality of remote POS location 70, the audio and/or visual interface being capable of automatically prompting a customer, in response to the customer's arrival at the remote POS location 70, with a greeting, the status of the connection between the customer and the remote order taking agent 12a, available promotions for the associated store, or a combination thereof.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

As will be described, the remote order processing system 1 detects the presence of a customer at a remote POS location 70, such as a drive thru POS location 70, and via a connectionless medium, initiates an order taking session, selects a remotely located agent 12a to take the customer's order, establishes communications, whether over the connectionless medium or otherwise, between the selected remote order taking agent 12a and the store 58, 60 and between the selected remote order taking agent 12a and the customer, and processes the order as it is received by the agent 12a from the customer to communicate the order to the store 58, 60 for fulfillment. Mechanisms are further provided to enhance the customer's experience, such as via optimized agent selection and/or intuitive order confirmation, detect and handle system failures, such as via back-up order in-take systems, and overall improve workflow efficiency both within the store and among multiple stores. In an alternative embodiment, the remote order processing system 1 is implemented so as to more easily integrate with a restaurant's existing technology infrastructure.

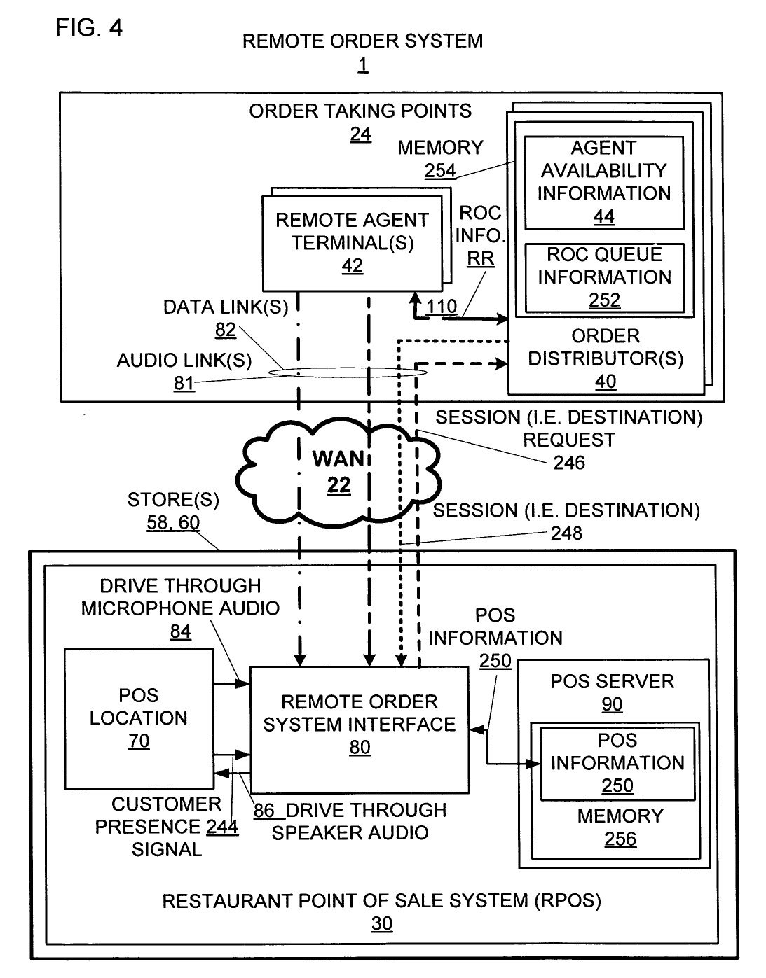

In the present embodiment, the system 1 includes a remote order system interface 80, also referred to herein as the system interface 80, order processing device, remote order center (“ROC”) interface or “ROClink” interface, and one or more speaker posts 2, 4 coupled with the system interface 80. Herein, the phrase “coupled with” is defined to mean directly connected to or indirectly connected through one or more intermediate components. Such intermediate components may include both hardware and software based components. The system interface 80 manages order intake and processing. The speaker posts 2, 4, described in more detail below, are used to communicate with customers and, in the present embodiment, are located proximate to the respective remote/drive through POS locations 70. In an alternative embodiment, the speaker posts 2, 4 may be provided within the store for communicating with a customer and receiving an order therefrom, in addition to or instead of at the drive through POS locations 70. The system interface 80 may further be coupled with one or more wired or wireless headsets 18, 20 as an alternative mode for receiving an order, as will be described. The system interface 80 is further coupled with the store's Restaurant POS (“RPOS”) system 30, or a terminal thereof, located within the store for processing or otherwise entering the order into the store's RPOS system 30 to facilitate at least fulfillment of the order. As will be described with respect to FIG. 4 below, the RPOS system 30 may include a POS server 90, one or more POS terminals (not shown), such as cash registers and/or order input devices, and one or more KVD's. The RPOS system 30 may be implemented as a centralized architecture, e.g. using dumb-terminals coupled with a central computer, or a distributed architecture, e.g. intelligent terminals coupled together as peer devices. In one embodiment, the RPOS system 30 is implemented as a client server architecture, i.e. a hybrid of the centralized and distributed architectures, where the POS terminals and KVD's are intelligent devices which execute client software that interacts via the network with the POS server 90 to implement the order processing/fulfillment applications. For example, the order processing/fulfillment applications may be implemented as an HTML or Web based application using Web or Browser client programs/interfaces, executing on the POS terminals and KVD's, and a server side application, executing on the POS server 90, all interconnected via an Intranet, the Internet or a combination thereof, such as by using TCP/IP based protocols. The system interface 80 may be coupled with a POS terminal, such as via a client side application interface or with the POS server 90 via a server side application interface, executing along with the order processing/fulfillment applications. It will be appreciated that the implementation of the RPOS system 30 may include any implementation now or later developed and that, as the mechanisms of coupling the system interface 80 with the RPOS system 30 are dependent on these implementations, all such mechanisms are contemplated herein. For example, the POS server 90 may be located external to the store, providing it functionality as a web service to which the store subscribes, connecting therewith using the aforementioned client applications executing on the POS terminals and KVD's.

The system interface 80 is further coupled with an order distributor 40, which may be remote from the store. The order distributor 40, as will be described, is coupled with a set of remote order taking agents 12a, each located at an associated remote agent terminal 42. In one embodiment, the order distributor 40 selects one remote order taking agent 12a/terminal 42 from the set for the purpose of taking the customer's order. The selected agent 12a then takes the customer's order using an audio connection established between the associated remote agent terminal 42 and speaker post 2, 4, via the system interface 80, as will be described in more detail below. The order distributor 40 may further be coupled with a store database 10, also referred to as a ROCLink store database, which stores store information for a plurality of stores.

The speaker posts 2, 4 are an interface between the system 1 and the customer, such as a customer present at one of the remote POS locations 70, for at least the purpose of taking the customer's order. For example, one or more speaker posts 2, 4 may be located at the store and may each be a separate free-standing device physically separate from the store and located along the store's drive-through lanes. Alternatively, one or more speaker posts 2, 4 may be located inside the store. In one embodiment, the speaker posts 2, 4 may be stand alone devices including audio speakers 2a and microphones 2b and a suitable controller to facilitate, e.g. receive and communicate/relay, audible communications between the customer and the remote order taking agent 12a at the remote agent terminal 42, either directly, i.e. peer to peer, or indirectly such as via the system interface 80. It will be appreciated that the logical connection, e.g. peer to peer or via an intermediate device, may differ from the physical implementation, e.g. a peer to peer logical connection may be established which physically routes via the system interface 80 while logically, the system interface 80 is not a party to the connection. The microphone 2b and the speaker 2a may be combined in some fashion, e.g. the same device may serve as both the microphone and speaker in a half-duplex implementation or, alternatively, the separate microphone and speaker devices may be combined as a single unit, such as mounted within the same housing. In one embodiment, the speaker posts 2, 4 may include a telephone, intercom or similar device, over which the customer communicates audibly. The speaker posts 2, 4 may also include a display that provides the customer with prompts, messages, indicators and/or cues which enhance the customer's interactive experience and satisfy the customer's need for feedback, such as a visual indication of the order components as they are entered and, possibly, a running total of the price of their order and/or other information, e.g. advertisements, etc. Other visual indications which may be provided to the customer include an indication that the presence of the customer has been detected and that an agent is forthcoming to take their order, an indication that an appropriate agent is in the process of being selected, such as based on the customer's dialect, an indication that the customer is presently connected with an agent, such as to prevent “dead air,” an indication that the customer should speak their next order component that they wish to order or otherwise indicate that they are finished ordering, an indication that there is a problem and that the customer should go to the service window or otherwise that assistance is forthcoming, or combinations thereof. The display may be located on the speaker posts 2, 4 or may be separate but proximate thereto. The speaker posts 2, 4 may further include signage such as a menu board or other display of the items/order components available for order, such as the restaurant menu. In one embodiment, a store may provide multiple speaker posts 2, 4. For example, with two drive-through lanes, each lane may have a speaker post 2, 4. In an alternate embodiment, the speaker posts 2, 4 may be remote terminals for receiving an order from a customer via unattended customer input, taking the customer's order, for example, via a keypad, touch screen and/or voice recognition.

In addition, the remote POS location 70, such as the speaker post 2, 4, includes a presence detector 2c, coupled with the speaker post 2, 4, which detects the presence of a customer at the associated remote POS location 70. Upon detection of a customer's presence, the presence detector 2c generates a signal/alert 3, 5 indicating the presence of the customer, i.e. a customer arrival alert. The presence detector 2c may further cause the display of a message or other indicator to the customer to acknowledge that the customer's presence has been detected, e.g. “your order taker will be right with you” or “please wait” or other suitable message or indicator in enhance the customer's interactive experience, as was described above. In one embodiment, this signal 3, 5 is sent to the system interface 80, as discussed below, to ultimately cause selection of an order taking agent 12a and the establishment of at least a data connection, e.g. a peer to peer connection, between the system interface 80 and the remote agent terminal 42 to allow the remote agent terminal 42 to indicate to the RPOS system 30, via the system interface 80, what the customer has ordered, as the order is placed. Further, via the same connection as used for the exchange of data, an audio connection may also be established, e.g. using Voice Over Internet Protocol (“VoIP”), between the customer and an remote agent terminal 42, such as via the speaker post 2 or 4. Alternatively, the audio connection may be established via an alternative connection or medium, such via the public switched telephone network, a private branch exchange, separate VoIP session or other medium of communications, or combinations thereof. In one embodiment for use at a drive-through restaurant, the presence detector 2c may be of a type that detects the presence of the customer's automobile, such as via an inductive, magnetic, pressure, optical or human based mechanism. It will be appreciated that the manner of detecting the presence of the customer is implementation dependent and may include manual detection means such as the pressing of a call-button or detection of a vocal annunciation by the customer, e.g. a voice activated presence detector 2c.

The system interface 80, in at least one aspect, acts as an intermediary that responds to the detection of a customer and facilitates connections between a remote order taking agent 12a, at their associated remote agent terminal 42, and the customer or store. The system interface 80 may be implemented in hardware, software or a combination thereof, and may include general purpose hardware, such as a personal computer or other computing device. In one embodiment, the system interface 80 may be implemented in software, so that it may be easily upgraded, modified and/or maintained. The system interface 80 may be a component of a POS terminal (not shown), located at the store, such as a standalone server or part of the POS server 90 of the RPOS system 30, located outside the store, or may be combined with one or more of the speaker posts 2, 4. In one embodiment, the system interface 80 may serve a plurality of stores. For example, the system interface 80 may be coupled with a set of restaurants located within a single city, such as a set of restaurants which may share a drive-thru POS location 70. In one embodiment, as described above, the system interface 80 receives the customer presence signal 3, 5 generated by the customer presence detector 2c based on the arrival and detection of a customer at one of the remote POS locations 70, such as the speaker posts 2, 4, e.g. based on an indication that a customer has pulled up to one of the speaker posts 2, 4, in their car. This signal 3, 5 may indicate not only that a customer is present but at which remote POS location 70, such as at which speaker post 2,4, the customer is present in embodiments having multiple speaker posts 2, 4.

The system interface 80, upon receiving this signal 3, 5 from the presence detector 2c, sends a customer arrival alert 7, also referred to herein as an order request, to the order distributor 40, as discussed below. The customer arrival alert 7 may be a signal and/or one or more messages, as will be described. In an alternative embodiment, the customer presence detector 2c may transmit the customer arrival alert 7 directly to the order distributor 40. In one embodiment, the customer arrival alert 7 is a data message, transmitted via a connectionless protocol, which indicates that a customer has arrived at the POS location and is waiting to place an order. A connectionless protocol is one in which a sender transmits a message by addressing the message to the recipient and placing it on a network to be delivered based on that address, but not otherwise establishing a connection with that recipient prior to transmitting. The exchange of communications in this way, for a given purpose, is typically referred to as a “session,” a “virtual connection” or “virtual call.” Once the purpose has ended, the session is ended. For example, a session may be established for taking a particular order and once the order is complete, the session is ended. The customer arrival alert 7 may further include identification information identifying the store, the store location, the particular remote POS location 70 and/or the customer, as discussed below. The customer arrival alert 7 may implicitly specify identification information such as where the alert 7 is conveyed over a dedicated identifiable connection used only by a particular store or remote POS location, etc. Alternatively, the customer arrival alert 7 may be one or more messages which explicitly specify/contain the identification information, or this information may specified via a combination of implicit and explicit specifications. In an alternate embodiment, the customer arrival alert 7 may also specify store information, also referred to herein as destination information, which may be used to assist the order distributor 40 in selecting an appropriate remote order taking agent 12a or set thereof, assist the selected remote order taking agent 12a in taking the order, or a combination thereof. Store information may include information about the particular store, information about the remote POS location 70 originating the customer arrival alert 7, information about the other POS locations 70 at the particular store and/or information about the customer, such as the store's operating hours, the store's menu, the current backlog of orders, the current queue depth at the particular remote POS location or all/other POS locations, the present inventory level of particular products, the status of the machines used by the store to produce particular products, any current promotions offered by the store, the language spoken by the customer, or combinations thereof. As will be described, store information, or a subset thereof, may be selectively communicated only when the information has changed subsequent to a prior communication of that store information.

It will be appreciated that the media over which the interactions 3, 5, 7 of the various described components, in addition to the interactions 11, 13, 14 between the order distributor 40, the remote agent terminal 42 and the system interface 80, occur as discussed below, and all other connections described herein, may include wired or wireless connections, including wired networks, wireless networks, or combinations thereof. Further, wherein the connections/interactions are implemented over one or more networks, these networks may include publicly accessible networks, such as the Internet, a private network, such as an intranet, or combinations thereof, and may utilize a variety of networking protocols now available or later developed including, but not limited to, TCP/IP based networking protocols.

As will be described, the system interface 80 is selectively coupled with a selected remote agent terminal 42, to facilitate a data connection between a remote agent terminal 42 and the system interface 80, in response to receiving a session request 13 from the selected remote agent terminal 42, the session request 13 having been generated in response to the customer arrival alert 7 being received by the order distributor 40 and the communication thereof to the selected remote agent terminal 42. This data connection is referred to as a session and is maintained for the duration of the order taking process as described herein and may be closed or ended when the order taking process is complete. The session is established for the transfer of indicators of one or more of the order components from the remote agent terminal 42 to the system interface 80 as the remote order taking agent 12a receives the order components from the customer, such as from the customer over an audio connection, and enters those order components into the remote agent terminal 42, described in more detail below. The system interface 80 may be further coupled with the RPOS system 30, as described below, to communicate order data, i.e. the received order component indicators, to the RPOS system 30 to ensure that the order is fulfilled at the store by transmitting or displaying the order information as discussed below. The system interface 80 may also facilitate an audio connection between the customer at the POS location 70, e.g. the speaker post 2, 4, and the remote order taking agent 12a at the remote agent terminal 42, allowing the customer and the remote order taking agent 12a to audibly communicate. It will be appreciated that once established, this audio communication need not flow through the system interface 80. In one embodiment, this audio connection may be implemented within the existing session for the data connection, such as by using Session Initiation Protocol (“SIP”)/VoIP or other protocol for implementing an audio connection over a connectionless network. Quality of Service protocols may be further implemented to ensure adequate and intelligible voice communications. Alternatively, the audio connection may be implemented outside of the system interface 80 via a separate medium of communication, including the PSTN.

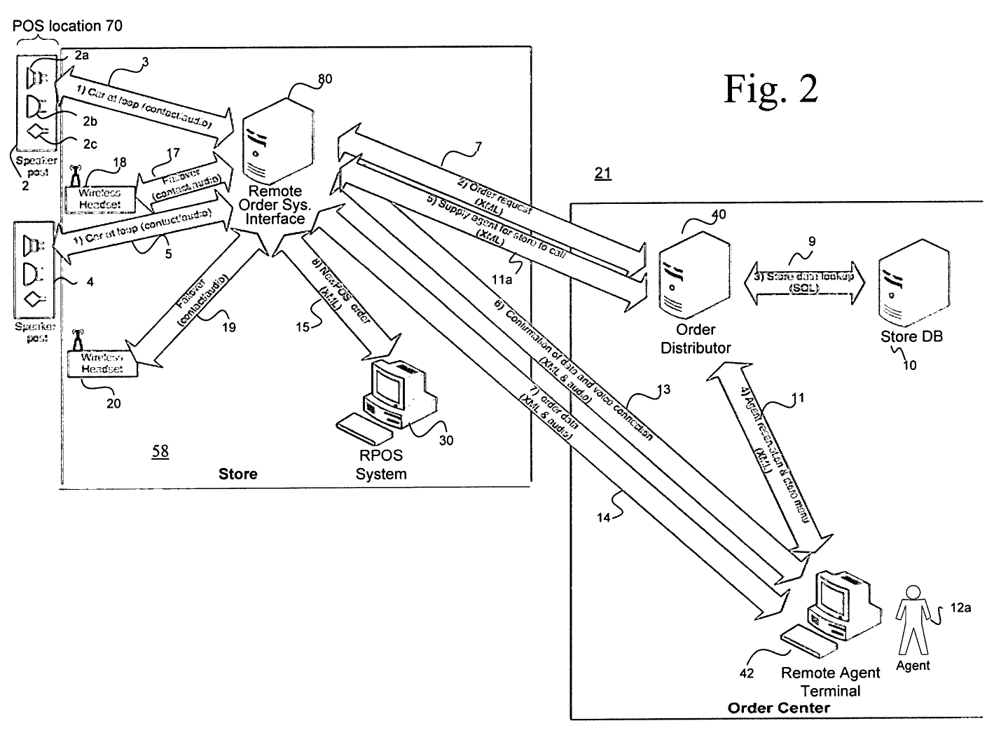

As described above, in response to the customer arrival alert 7, the order distributor 40, alone or in concert with the system interface 80, selects an remote order taking agent 12a at a remote agent terminal 42, from a set of remote order taking agents 12a, which will then initiate communications with the customer via the system interface 80. However, in some installations of the disclosed system 1, it may be necessary to integrate the disclosed system 1 with an existing technology infrastructure, such as an existing communications network. Alternatively, the store may have particular concerns regarding the security of the communications between the customer and the remote order taking agent 12a. These concerns may be addressed by having the system interface 80 instead initiate the communications with the selected remote order taking agent 12a. FIG. 2 shows such an alternative embodiment wherein, in response to the customer arrival alert 7, the communications between the customer and the remote order taking agent 12a is initiated at the store by the system interface 80 rather than by the remote order taking agent 12a. This permits the system interface 80 to exert more control over the manner in which such communications are implemented, i.e. security protocols, desired communication path, etc. Further, where a store has a communications network with a firewall device which may block unsolicited communications, i.e. would block remote order taking agent 12a initiated communications, the initiation of communications from within the store, i.e. behind the firewall, would create a solicited relationship with the remote order taking agent 12a/remote agent terminal 42 thereby allowing the communications therebetween to flow unimpeded through the firewall, without requiring modification of the firewall protections. In this alternative embodiment, the system interface 80 receives a session request 11a from the order distributor 40 to set up a session with the selected remote agent terminal 42, selected by the order distributor 40 in response to the customer arrival alert 7 that the system interface 80 previously transmitted, as described below for the agent-initiated embodiment. The session request 11a may include information related to the selected remote agent terminal 42 to ultimately cause at least a data connection to be established between the system interface 80 and the remote agent terminal 42. In one embodiment, the session request 11a may identify a set of remote agent terminals 42 for the system interface 80 to choose from, the set being selected as described herein. Further, via the same mechanism, an audio connection may also be established between the customer, such as via the speaker post 2 or 4, and an remote agent terminal 42 using, for example, VoIP as described above. Alternatively, the audio connection may be established via an alternative mechanism, such via the public switched telephone network, a private branch exchange or other medium of communications, or combinations thereof.

It will be appreciated that the functions of the order distributor 40 may be integrated with the system interface 80 allowing the system interface 80 to select an appropriate remote order taking agent 12a in response to receiving a customer arrival alert 7, without first having to communicate with the order distributor 40. In this embodiment, there may be no order distributor 40 or, alternatively, the order distributor 40 may manage and monitor the remote order taking agents 12a and supply such information to the system interface 80 asynchronous to the order taking process to keep the system interface 80 up date as to the status of the various remote order taking agents 12a, thereby allowing the system interface 80 better select an appropriate remote order taking agent 12a.

In this system interface 80 initiated embodiment, the system interface 80 may then provide store information to the remote agent terminal 42 rather than this information coming from the order distributor 40, as described below. Alternatively, the order distributor 40 may also be in communication with the selected remote agent terminal 42 to, for example, provide store information or to alert the selected remote order taking agent 12a or remote agent terminal 42 to expect a session to be initiated by the system interface 80. Once initiated, the order process and flow of communications is similar to the agent-initiated embodiment. Further, the system interface 80 and/or order distributor 40 may provide store information to, or otherwise alert, one or more alternate remote order taking agents 12a to be ready in case of a failure of communication with the first selected remote order taking agent 12a.

Referring back to FIG. 1, the order distributor 40 is coupled with the system interface 80 and one or more remote agent terminals 42, each of which is associated with a remote order taking agent 12a. In one embodiment, there may be a plurality of order distributors 40. Each of the plurality of order distributors 40 may be located at different locations to provide redundancy or to serve different stores and restaurants or subsets thereof. The order distributor 40 may include a switch, router, computer programmed to distribute orders, or any suitable device to distribute orders or combinations thereof. The order distributor 40 selects a particular remote order taking agent 12a and remote agent terminal 42 to handle an order, making its selection from a plurality of remote order taking agents 12a and associated remote agent terminals 42. This selection may be based on a number of factors as discussed below. The order distributor 40 may further select one or more alternate remote order taking agents 12a so as to anticipate any problems which may prevent use of the first selected remote order taking agent 12a. As was described above, in one embodiment, the order distributor 40 receives identification data, at least identifying the store or restaurant where the customer is located, from the system interface 80 via the customer arrival alert 7. This identification data is then transferred to the selected remote agent terminal 42, for example, to inform the remote order taking agent 12a of the location of the customer and/or to cause the terminal 12 to automatically display a store-specific interface or menu, or normalized version thereof. The identification data may include a phone number for a call back, an IP address, or a directory address to identify the store or POS location 70 for establishing a connection between the customer and the remote agent terminal 42. In embodiments where the customer arrival alert further includes store information, this store information may be similarly passed to the remote agent terminal 42.

Store information may include either data that is likely to change often, i.e. dynamic data, and data which is less likely to change, i.e. static data, or a combination thereof and different store information, or subsets thereof, may be sent in different customer arrival alerts. To avoid the inefficiencies associated with re-transmitting the same data repeatedly, such as the decrease in overall transmission throughput and increased bandwidth requirements, or to eliminate such transmissions entirely, the order distributor 40 may be coupled with the store database 10 which stores store information regarding one or more stores, as further discussed below. In response to a request from the order distributor 40 identifying a particular store, the store database 10 may transfer store information for the particular store to the order distributor 40, or directly to the selected remote agent terminal 42, through the store data lookup connection 9. The store database 10 may be a personal computer or a computer storage device such as a hard drive. The store database 10 may be a separate device from the order distributor 40 or may be part of the same device.

As described above, the customer arrival alert signal 7 may include store information which has changed and for which it therefore may be necessary to update the store database 10. Store information may include the current conditions of the store, such as the availability of products, the number of customers waiting, the wait time for a customer at the store, promotion information, such as available coupons, rebates, or sales, or customer language information. For example, individual restaurants may have different menus and the order taker will need to use the correct menu based on the particular restaurant they are servicing. An example of a promotion would be if the store is trying to sell 1000 hamburgers in a single day. That information may need to be sent to the remote agent terminal 42 as discussed below, so the remote order taking agent 12a can notify the customer of the promotion. In the example of a drive-through restaurant, additional store information may include drive-through queue information (the determination of which is described in more detail below), such as the customer back-log, traffic information, weather information, drive-through data, and kitchen queue and/or capacity information for one or more kitchens in the store. For example, if there are 10 cars in the drive-through queue, that information would suggest that the order takers need to be extra prompt in receiving and entering the order. Additionally, the kitchen queue and/or capacity information may inform the remote agent terminal 42 that one or more of the kitchens at the store is behind on orders, is having equipment or staffing difficulties, has exhausted the inventory of a particular product and/or product fulfillment is delayed, e.g. the kitchen will not have french fries ready for five minutes, so customers should be notified of the delay in receiving their order if they are planning to order, or have already ordered, french fries. In this case, the remote order taking agent 12a may be trained, or otherwise automatically prompted, to direct the customer to an alternative product choice so as to assist in alleviating the burden on the store or kitchen.

As described above, dynamic data is data that is likely to change for each order while static data is the data that is less likely to change. For example, queue information such as at the drive-through or the kitchen queue may be dynamic data because it is likely to change at any given moment. Static data may include the menu or promotion information, such as available coupons, rebates, or sales, which is less likely to change over a given period of time, such as over the course of a day. In one embodiment, the store information that is transmitted with the customer arrival alert 7 from the system interface 80 to the order distributor 40 may, in most occurrences, only include dynamic data while the store database 10 maintains the static data for a plurality of stores, thus eliminating the need to transmit the static data for every customer, order or transaction. Further, should the static data change, only the updated static data needs to be transmitted with a subsequent customer arrival alert 7 to update the store database 10. The relationship between the remote agent terminals 42 and the store database 10 is similar to the relationship between the store database 10 and the system interface 80, i.e. where store information is provided to the remote agent terminals 42, such information may be stored in the remote agent terminals 42 such that this information need only be retransmitted from the order distributor 40/store database 10 if the information has changed. It will be appreciated that standard principles of data caching, including protocols to minimize missing in the data cache, e.g. minimum data block sizing, maintain data coherency and prevent stale data, may be implemented, including an invalidation protocol, data expiration controls and/or pre-emptive caching of data, e.g. transmitting static data in advance of any order rather than concurrent therewith. Further, peer-to-peer (“P2P”) distribution protocols may be utilized allowing one remote agent terminal 42 to obtain such data from another remote agent terminal 42 rather than from the order distributor 40/store database 10, such as to provide redundant or otherwise reliable data distribution. In determining when an update is necessary, the system interface 80, as between the system interface 80 and the order distributor 40/store database, and/or the order distributor 40/store database 10, as between the order distributor 40/store database 10 and the various remote agent terminals 42, may maintain a table or other database which identifies what data has been previously sent so that it may be determined who needs to be updated. Alternatively, the system interface 80 and order distributor 40/store database 10 or order distributor 40/store database 10 and the various remote agent terminals 42 may implement a protocol whereby the data recipient validates its data with the source, such as by sending a conditional request including a checksum, hash value, tag or fingerprint unique to the data which the recipient already has stored which can be verified by the data source to determine if the recipient is presently storing stale data.

In one embodiment, customer arrival alerts 7 for a particular restaurant are transmitted to the order distributor 40 from the system interface 80 including store information that is dynamic but only store information that is static where that static information has changed subsequent to a prior transmission. The dynamic data can then be transmitted to the remote agent terminal 42 as required. In this embodiment, the static data does not need to be transmitted with each new alert 7 because the store database 10 maintains a record of all of the static data. The order distributor 40 can retrieve the static data from the store database 10 and transmit it to the remote agent terminal 42 if necessary, e.g. if the remote agent terminal 42 needs to have its copy of the static data updated. However, as noted, the static data may need to be transmitted to the order distributor 40 and to the store database 10 if it has changed, or otherwise been updated or modified. For example, if a store runs out of a particular item, then that may result in a change to the menu. The updated static information is transmitted from the system interface 80 to the order distributor 40 to the store database 10 to update its records. Alternatively, if a store decides to discontinue a promotion, such as fifty cent cheeseburgers, then the static information that included this promotion would need to be updated to indicate the promotion has been discontinued. Additionally, for the first transaction for a particular store, all of the static data will need to be transmitted to the store database 10 to establish the record of static data for that store within the store database 10. Alternatively, the static data could be stored in the store database 10 and/or distributed to the remote agent terminals 42 in advance of the first order via an alternative means, such as by a separate dedicated transmission.

Once the order distributor 40 receives a customer arrival alert signal 7/order request from the system interface 80, the order distributor 40 selects a remote order taking agent 12a with an associated remote agent terminal 42 to handle the order. In one embodiment, the remote order taking agent 12a is a human being. In an alternative embodiment, the remote order taking agent 12a may be implemented in software, hardware or a combination thereof, such as an artificial intelligence based interactive voice response system. The remote agent terminal 42 may be a personal computer or computing device with a network connection as discussed below, with the appropriate hardware such as a headset with a microphone and earpiece for a remote order taking agent 12a to interact with, e.g. speak and listen to, a customer. A software program may present the appropriate information to the remote order taking agent 12a, such as an on a display coupled with the terminal 12, to allow the remote order taking agent 12a to properly interact with the customer and receive, validate and enter the order into the terminal 12. This information may include the menu, promotions and/or specific POS terminal interface screen stored on the remote agent terminal 42 or provided by the order distributor 40 or system interface 80.

In one embodiment, software is provided which replicates the interface of a register located within the actual store on the display of the remote agent terminal 42. For example, a customer inside a fast-food restaurant tells an employee at a restaurant what he/she would like to order and the employee enters the information into a register having dedicated keys for the item, as was described above. Likewise, the remote order taking agent 12a is presented with a similar interface having similarly dedicated inputs, such as a set of virtual buttons which mimic the register interface. Alternatively, the software may normalize the variations in the menus among the stores 58, 60 so as to present a consistent user interface to the agent 12a that reflects the menu variances in an intuitive manner. The remote order taking agent 12a receives a customer's order through a data or audio connection and enters that order into the remote agent terminal 42 and the order data is then transmitted back to the store through the data connection as described herein.

The remote order taking agent 12a and remote agent terminal 42 may be located at a variety of locations. Remote order taking agents 12a may be located on-site at the store or POS location 70, or may be located remotely therefrom such as at a remote-order center/call center or located in their home as discussed below. The disclosed embodiments permit the remote order taking agent 12a to be located away from the remote POS location 70 with a data or audio connection established between the customer at the remote POS location 70 and the remote agent terminal 42, as was described above. Further, as remote order taking agents 12a may not be directly or permanently connected with any one store 58, 60 or POS location 70, each may handle order requests for a wide variety of stores 58, 60 and/or POS locations 70. For example, individual remote order taking agents 12a may receive orders from a chain of fast food restaurants located across the country. The remote agent terminal 42 may take orders from different restaurant locations or even receive orders from different restaurant chains. Alternatively, it may be advantageous to select order taking agents 12a that are familiar with a particular restaurant or that meet the criteria as discussed below. Order taking agents 12a may be located within the same geographic regions, e.g. city, county, state and/or country, as the store, or in a different geographic region. In one embodiment, order taking agents 12a are located in one or more different time zones so as to be able to provide available order taking agents 12a, working during the normal business hours of their location, to take orders at any time of day from any particular store. This permits, for example, 24 hour order taking capability without having to pay order taking agents 12a overtime or special pay or otherwise requiring them to work beyond their normal business/working hours.

In one embodiment, there may be a remote order center (“ROC”), also referred to as a remote call center, (not shown) that houses a number of remote order taking agents 12a. The remote order center may include an order distributor 40 which receives customer arrival alerts 7/order requests that may specify a specific remote order taking agent 12a or the remote order center or order distributor 40 may choose an appropriate remote order taking agent 12a. The remote order center may include its own order distributor 40, or the order distributor 40 may be located outside of the remote order center. The remote order center may house a number of remote agent terminals 42 wherein the order distributor 40 selects an remote agent terminal 42 based on the characteristics of the remote order taking agents 12a working at the remote order center, or some other parameters. In an alternate embodiment, the remote agent terminal 42 and the remote order taking agent 12a may be located at home and suitably coupled with an order distributor 40, such as via a digital subscriber line (“DSL”), cable modem, dial-up or wireless connection.

In one embodiment, the order distributor 40 selects a remote order taking agent 12a that is appropriate to handle the particular order. This selection may be based on the identification information and/or store information provided with the arrival alert 7 and/or retrieved from the store database 10 and further based on profile information, known or provided to the order distributor 40, regarding the various available remote order taking agents 12a. For example, selection of a remote order taking agent 12a may be based on agent availability, store or menu familiarity, historical experience with the particular store, production demand, expertise, regional, cultural or linguistic compatibility or capability, order taking speed, order taking accuracy or combinations thereof. Some selection criteria may be absolute requirements, such as language compatibility, while other criteria are merely preferential, such as cultural compatibility. In selecting a remote order taking agent 12a, preferential criteria may be suppressed or otherwise de-prioritized when production demand is high and agent availability is low. For example, for a restaurant in Chicago, an order taker may be chosen who has a Midwestern or Chicago accent. A customer in the Midwest may ask about which “pops” are available, however, in the South, the customers' instead use the term “sodas.” These regional/cultural differences may be considered when selecting an remote order taking agent 12a and the associated remote agent terminal 42. Likewise, if a store is located in the South, an order taker with a Southern accent may be preferred. The order distributor 40 may have access to a directory, for example maintained in the order distributor 40, of any potential remote order taking agents 12a, which includes data on the availability of the remote order taking agents 12a and information regarding their capabilities or training such as language, dialect, and familiarity with individual stores. This directory may be updated in real time to reflect remote order taking agent 12a availability or capabilities. For example, the remote agent terminals 42 may feature attendance tracking software which determines when a remote order taking agent 12a is present at or absent from the remote agent terminal 42 and prepared to take orders, such as by requiring the agent 12a to log in and out. The order distributor 40 may first select an remote order taking agent 12a based on the availability information and secondarily on other factors as described. For example, if an remote order taking agent 12a needs to take a lunch break, then the order taker may notify the order distributor 40 that he/she is currently unavailable and the order distributor 40 will not select that remote order taking agent 12a until the order distributor 40 receives a notification, i.e. the directory is updated, that the remote order taking agent 12a is back and that remote agent terminal 42 is again available.

As described above, individual remote order taking agents 12a may already have store information for each store stored in their remote agent terminal 42, either pre-loaded or as a result of handling a prior order from that same store, which may influence the selection of that remote order taking agent 12a. This information may be reflected in the directory described above. If the remote order taking agent 12a has already handled a prior order for a particular restaurant, then he/she may be selected to receive subsequent orders from that same restaurant because new store information does not need to be transmitted to the associated remote agent terminal 42, saving time in readying the remote order taking agent 12a to take the order. As discussed above, the store database 10 or the order distributor 40 may be storing static data for a particular store, which may be transmitted to the remote agent terminal 42 the first time that remote agent terminal 42 is selected to handle an order for that particular store. Subsequently, a remote agent terminal 42 with the appropriate static data will not need to receive the same data again, unless, as described, that data has changed. Therefore, the order distributor 40 does not need to retrieve the static data for the store from the store database 10 and does not need to transmit that data to the remote agent terminal 42. Accordingly, the order distributor 40 is likely to choose a remote agent terminal 42 that already has the static data for the particular store. As discussed above, the remote agent terminal 42 may still receive the dynamic data or any updates or changes to the static data just as the order distributor 40 receives that data. The selection of a remote order taking agent 12a that already has the static data for a particular store results in less data being transferred to the remote agent terminal 42, which may result in a quicker and more efficient response. Further, a remote order taking agent 12a that has taken previous orders from the store is likely familiar with the store and its menu or products and, having received multiple orders from the same store, is likely to be more efficient at receiving and entering the order. Where the static data has changed, the order distributor 40 may ignore or de-prioritize an order taking agent's 12a historical experience with the particular store as a selection criteria since the static data will need to be transmitted anyway negating that advantage in selecting that remote order taking agent 12a. Alternatively, historical experience may still be relied on even if the static data needs to be transmitted as that agent 12a's prior experience/familiarity with the particular store and/or menu may be advantageous despite that there may be delay in providing the static data.

Once a remote order taking agent 12a and associated remote agent terminal 42 is selected, the order distributor 40 transmits an order initiation signal 11 to the selected remote agent terminal 42 that may include the customer arrival alert signal 7 and additional store information, such as the store information, static data, or dynamic data as discussed above. For example, if a restaurant is offering cheeseburgers for $1, then that information will be transmitted to the selected remote agent terminal 42 along with the order initiation signal 11 as static data if this is the first time the remote agent terminal 42 has received an order from that restaurant. Subsequently, when the same remote agent terminal 42 receives a subsequent order initiation signal 11 indicating an order from that restaurant, the cheeseburgers-for-$1 information will not be transmitted to the remote agent terminal 42 because the remote agent terminal 42 already has that information. The remote agent terminal 42 may maintain a record of the static data for all future orders from that restaurant. If the restaurant were to run out of hamburgers or cancel the sale, then the static data will need to be updated. Consequently, the next order initiation signal 11 received will include an update to the static information either canceling the promotion or updating the menu to show that hamburgers are unavailable. As discussed above, the order initiation signal 11, in the agent initiated embodiment, will cause the remote agent terminal 42 to initiate the connection with the system interface 80 and/or remote POS location 70. Alternatively, in the store interface initiated embodiment, the order initiation signal 11 may alert the remote agent terminal 42 of the expected session initiation by the system interface 80 or, alternatively, the order initiation signal 11 may come from the system interface 80 as part of the session initiation.

In an alternate embodiment, the static data is updated in the store database 10 and not with the remote agent terminal 42, where the remote agent terminal 42 receives all of the static and dynamic data with each order initiation signal 11. Such a scenario may be necessary if, for example, the order distributor 40 oversees a very large number of stores and remote order taking agents 12a. The system may function more efficiently by choosing remote order taking agents 12a based only on availability. In this embodiment, the dynamic data and the static data is transmitted to the remote agent terminal 42 for each order from each store. Accordingly, the remote agent terminal 42 would not need to record the static data for individual stores because that data is transmitted for each order.

The order initiation signal 11 from the order distributor 40 to the selected remote agent terminal 42 may also include contact information for the store, which the remote order taking agent 12a and/or remote agent terminal 42 may use to establish a connection with the store and specifically, a connection with the customer. The selected remote agent terminal 42 may then send a session request 13 to the system interface 80, or alternatively, specifically to the speaker post 2. As discussed above, in an alternate embodiment, as shown in FIG. 2 and order processing system 21, the system interface 80 may send a session request 11a to the order distributor 40 or the selected remote agent terminal 42, rather than the selected remote agent terminal 42 sending a session request 13.

The session request 11a, 13 is an attempt to establish a session between the customer or store and the selected remote agent terminal 42. During this session, there may be multiple connections established between the customer or remote POS location 70 and the selected remote agent terminal 42 for different purposes, such as a data connection for the transmission of an order and an audio connection allowing the customer to speak with the remote order taking agent 12a. For example, an order data connection 14 may be established by the selected remote agent terminal 42 to transmit the order to the store or RPOS system 30 through the system interface 80. The audio connection may be substantially simultaneously established through a standard phone line or a Voice over IP (VoIP) connection. The customer talks into the speaker post 2, 4 through the audio connection with the selected remote order taking agent 12a for communicating the items or order components the customer would like to order to the remote order taking agent 12a who enters them into the remote agent terminal 42. Where the audio connection is a VoIP connection, it may share the same session as the order data session 14. In other words, the audio data may be transmitted along with the order data.

For example, the customer at a drive-through POS location 70 is connected through some form of an audio connection via the speaker post 2, 4 with a selected remote order taking agent 12a. The customer is prompted by the remote order taking agent 12a for their order and the customer then tells or otherwise provides the remote order taking agent 12a what items/order components he/she would like to order, this being communicated to the remote order taking agent 12a. As the remote order taking agent 12a hears the customer articulate each order component, the remote order taking agent 12a inputs the order component into their remote agent terminal 42, such as via a virtually generated store-specific-POS-terminal-interface or normalized interface, as discussed above. The entry of an order component into the remote agent terminal 42, as it is entered by the remote order taking agent 12a, causes the generation of order data identifying the ordered order component and the transmission of that order data to the store or system interface 80. Alternatively, two or more order components may be grouped together for transmission, such as where the order components are received and entered into the remote agent terminal 42 within a specified period of time, e.g. within 200 milliseconds of each other. It will be appreciated that the grouping of order components for transmission back to the store or system interface 80 is implementation dependent and that the decision to hold the transmission of one or more order components so that they can be grouped depends on balancing communication efficiency with the maintenance of at least the illusion of real time feed back to the customer and/or not inhibiting the order fulfillment process of the store, as described herein. In one embodiment, as the order data is received from the remote agent terminal 42, the order data may be provided to a display proximate to the speaker post 2, 4 such that the customer may see a display of the items or components that the remote order taking agent 12a has already entered, the display being updated as the order components are entered. This operation is performed substantially in real-time, to give the customer the sense of an interactive experience, allow the customer to acknowledge the accuracy of the order, allow the customer to detect any errors as soon as possible and/or simply to prompt the customer to reflect on his decisions. The customer may then inform the remote order taking agent 12a if there are any errors or if the customer would like to change any of the order components or items in the order. Alternatively, if there is no display screen for the customer, the remote order taking agent 12a may audibly repeat the order via the speaker post 2, 4 so the customer can acknowledge that it is correct. When the remote order taking agent 12a finishes entering the order components and the customer has no more items to order, the remote order taking agent 12a may inform the customer of the total price, offer any discounts, upsells, cross-sells or otherwise announce any promotions or informational messages, and further may inform the customer where to go to pay and/or pick up the ordered items. The connection/session is then ended and the remote order taking agent 12a becomes available to take an order from another customer from the same or another store.

The store's RPOS system 30, also is coupled with the system interface 80, as described above, and operative to receive customer or order information including receiving the order data, substantially as it is entered by the remote order taking agent 12a and transmitted to the system interface 80, for the purposes of fulfilling the order and otherwise integrating the order into the store's workflow, e.g. inventory management, etc. The RPOS system 30 may be located within the store at the POS location. In one embodiment, the store's RPOS system 30 is coupled with the communication network within a store and may include connections with the system interface 80. As discussed, the RPOS system 30 may include the POS terminals, e.g. cash registers within a store and other order fulfillment stations, such as KVD's, as well as the POS server 90.

In one embodiment, the RPOS system 30 may receive an order from the remote agent terminal 42 through an order connection 15 and the system interface 80, rather than an employee at the store entering the order into a POS terminal. The RPOS system 30 can transmit the order to at least one POS terminal, which an on-site employee then uses for fulfillment of the order and for collecting payment. In one embodiment, a store may have POS terminals as part of the RPOS system 30, some of which receive orders from a remote agent terminal 42, and others, which receive orders from on-site employees.

For example, a POS terminal in the RPOS system 30 may display the order components and the price for the items. An employee at the store or the store register then makes/manufactures/prepares the order components or instructs them to be made, or otherwise gathers them into a complete order to be given to the customer. The employee then requests the payment from the customer based on the amount shown by the POS terminal. The POS terminal may then further be used to receive payment, such as by credit card or cash. Once payment is received the order is fulfilled, and the POS terminal can receive the next order.

As described, in response to a customer arrival signal 3, 5 indicating the presence of a customer waiting to place an order, the system interface 80 sends a customer arrival alert 7 to the order distributor 40 which then selects an appropriate remote agent terminal 42 to initiate a session with the system interface 80 for the purposes of transmitting order data back to the system interface 80 and substantially simultaneously establishing an audio connection for the purpose of receiving the order from, or otherwise communicating with, the customer. While the mode of the audio connection may vary, the failure to establish such a connection is important to determine as soon as possible so as to enact fail over mechanisms as quickly as possible to handle the customer's order. In particular, in one embodiment, should a failure to establish the session, the audio connection, or both, occur, the system 1 automatically detects the failure and enacts a fail over mechanism to handle the order. In this way, the customer's order, and the fulfillment thereof, is prioritized. Further, incomplete connections are avoided. For example, an audio connection between the customer and the remote order taking agent 12a would not be established when the remote order taking agent 12a has no way to transmit the order back to the system interface 80, as such a situation wastes the order taking agent's 12a time and promotes customer frustration. In failure situations, the system 1 may select an alternate remote agent 12a to handle the order or defer to the personnel at the store to take the order. In particular, where the system 1 is able to determine that the problem is with the specific agent 12a, another agent 12a would then be selected. However, where the problem is preventing connections with any remote order taking agents 12a, then the system 1 directs the order to be handled at the store.

The wired or wireless headsets 18, 20 are operative to establish an audio connection with a customer at the speaker posts 2, 4. In one embodiment, each headset is associated with a speaker post 2, 4 and permits the wearer to listen in and/or participate in any communications occurring with the speaker post 2, 4, such as an order being handled by a remote order taking agent 12a. The headsets 18, 20 may connect with the system interface 80 through failover connections 17 and 19, respectively, described in more detail below. The system interface 80 is coupled with the speaker posts 2 and 4. The headsets 18, 20 have a microphone and speaker for communicating with the customer. The speaker may be an earpiece or headphones. In an alternate embodiment, the headsets 18, 20 may be wired within the store to establish a wired connection with the speaker post or with the system interface 80.

If the connections 13 or 14 between the remote order taking agent 12a or the order distributor 40 and the system interface 80 were to fail for any reason, then the system 1 must have a backup or fail-safe plan for receiving customer's orders, as was described. If either the audio or data connection fails, then the order may be received by employees within the store via the headsets 18, 20. If the audio connection fails, then the customer and the remote order taking agent 12a would be unable to communicate. If the data connection fails, then the remote order taking agent 12a would be unable to transmit the order data to the store. In either circumstance, the order taking responsibility reverts back to the store and employees, with headsets 18, 20, who can then communicate with the system interface 80 through the failover connections 17, 19 which take over the communication, either automatically or via manual intervention. The headsets 18, 20 allow an employee to establish audio contact with the customer to receive the customer's order. The employee may then enter the order into the RPOS system 30, in one embodiment, picking up where the remote order taking agent 12a left off based on the order data transmitted thus far, as displayed on the POS terminal, before the failure. Similarly, if an alternate remote order taking agent 12a is selected to take over the order, they may also be provided with the present status of the order so as to be able to pick up where the previous remote order taking agent 12a left off.

For example, when the fail safe mode is activated, the order components that have already been transmitted by the remote order taking agent 12a are already entered into the RPOS system 30. For example, a customer at a drive-through says “I would like to order two cheeseburgers and large fries.” The selected order taker enters 2 cheeseburgers and that data is transmitted to the store or interface, however, the data connection or audio connection then fails. The fail safe mode is activated with part of the order already entered, e.g., two cheeseburgers have already been recorded and received by the restaurant. An employee with a wireless headset 18 then establishes an audio connection with the customer in the drive-through, determines, from the POS terminal, what has been ordered thus far, and says “I have 2 cheeseburgers for you, would you like anything else?” The customer can then finish the order with the employee entering the remainder of the order into the POS terminal. In this way, the customer may never be aware that a failure occurred, maintaining customer satisfaction and confidence.

In one embodiment, the remote order processing system 1 is part of/owned and operated by an overall order processing system of a restaurant or chain of restaurants. In an alternative embodiment, the remote order processing system 1 is provided as a service to one or more restaurants and/or restaurant chains. This service may be provided on a subscription or fixed fee basis, such as a monthly or yearly fee, basis, on a per-order/transaction basis, on a time basis, such as per minute or per second charge measured over the total time of the transaction or multiple transactions over a defined period, or a combination thereof. For example, a restaurant or restaurant chain may contract with such a service to handle all orders or a fixed number of orders over a set period, such as 1 year, such as to supplement an existing order taking mechanism. Alternatively, a restaurant or restaurant chain may contract with the service to handle overflow orders, such as those order which exceed the restaurant's or chain's own order taking capacity, e.g. lunch or dinner rush or during staffing shortages, weekends, holidays, etc. In an alternative embodiment, the fees charged may be fixed, or variable, such as based on, time of day, day of week, volume of orders or based on the value of the orders handled, e.g. based on gross or net margin, thereby incentivising the service to sell more products and/or more profitable products to customers. In one embodiment where a fee is charged per second, or some other period, of the transaction time, the rate may diminish as the transaction takes longer to encourage fast and efficient order taking, i.e. the first few seconds are more expensive then the later seconds of the transaction, etc. It will be appreciated that the above methods of compensation may be combined to create a pricing system which meets the mutual needs of the service provider and the customers. To implement the particular fee structure, software may be included in the system interface 80 and/or order distributor 40, or elsewhere within the system 1, such as in a separate device, which monitors and/or records the appropriate parameters for billing purposes. The acquired data may then be provided to the service provider, such as to a billing server which handles the billing/accounting functions. Mechanisms may further be provided to allow service subscribers to monitor account/billing activity for audit or other purposes.

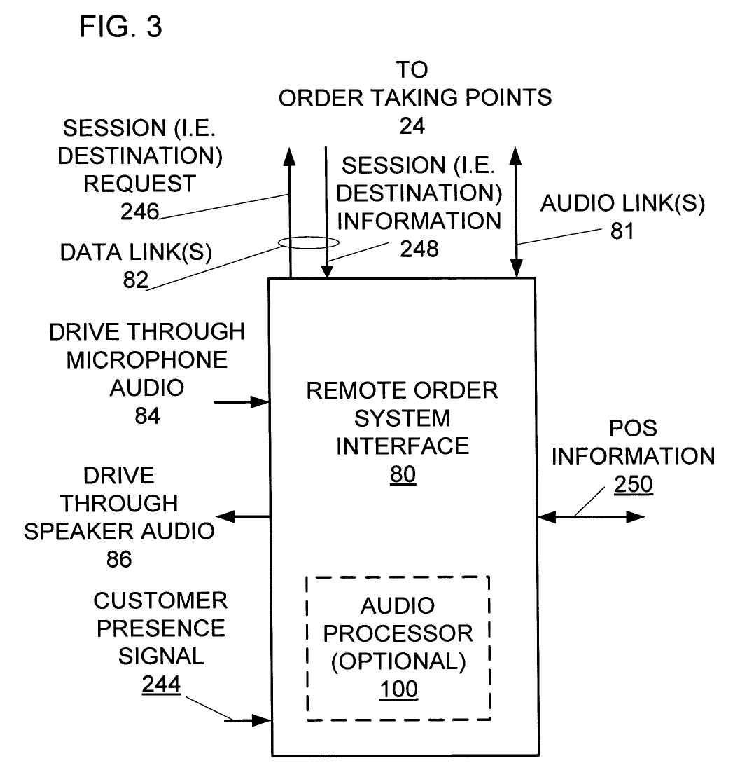

The system described above is further described in more detail with reference to FIGS. 3-10. In particular, FIG. 4 shows another alternative embodiment of the remote order processing system 1. Further, FIG. 3 shows a block diagram of one embodiment of the system interface 80. The system interface 80, further described with respect to FIG. 3, is a part of the exemplary remote order processing system 1. According to one embodiment, the system interface 80 includes an optional audio processor 100.

FIG. 4 shows a block diagram of the remote order processing system 1 for use with the system interface 80 of FIG. 3. The remote order processing system 1 includes one or more stores 58, 60, a wide area network (WAN) 22 and a plurality of order taking points 24, each including one or more remote agent terminals 42 with remote order taking agents 12a. FIG. 4 further shows one embodiment of the order distributor 40 coupled with the remote agent terminals 42.

As an overview, the remote order processing system 1, the system interface 80 and/or the order distributor 40 efficiently receives and manages orders from one or more stores 58, 60 and distributes the handling of the orders to the order taking points 24. For example, the system interface 80 may send POS information such as menu and/or other store information to the order distributor 40. The order distributor 40 may select the most appropriate remote agent terminal 42 based on the POS information sent by the system interface 80 and/or based on agent availability information known to or discernable by the order distributor 40. In an alternate embodiment, the order distributor 40 may send agent availability information to the system interface 80 to allow the system interface 80 to select an appropriate order taking agent at a remote agent terminal 42. The order distributor 40 and/or the system interface 80 may also regulate the flow of orders back to the stores or otherwise assist the RPOS system in efficiently managing and load balancing order traffic amongst the productions lines in the various stores and adapt to changes in orders. As a result, the remote order processing system 1 reduces the time for order intake, increases production, reduces customer queues and increases customer satisfaction.

In addition, the remote order processing system 1 may alleviate or even eliminate the order processing bottleneck and thus permit an increase in production, thereby increasing revenue and profits. For example, in prior systems, a cashier/counter person would be required to both take orders and deliver orders to customers. By providing remote order taking points 24 dedicated to the order taking function, in-store employees may remain focused on their primary task without the distraction of having both take and fulfill orders. In addition, the remote order processing system 1 efficiently consolidates order processing functions of multiple stores, through, for example, the use of one or more order distributors 40 to distribute orders to remote agent terminals 42. These remote agent terminals 42 may be located at one or more order taking points 24, such as remote order centers and/or at an agent's home. Remote order taking agents 12a are specialized in receiving a customer's order and improve a store's 58, 60 efficiency through optimization of the labor within the store 58, 60. Thus, the centralized management of remote order taking agents 12a improves efficiency and reduces overall labor costs. Across multiple stores 58, 60, remote order taking agents 12a may be reallocated based on demand and available resources to efficiently service multiple establishments with less resources than would be otherwise required. The remote order taking agents 12a need only specialize in taking orders and do not need to also function as a cashier and/or food handler. For example, the remote order taking agent 12a may be trained to quickly, accurately and efficiently convert a customer's verbal request into a food order. In another example, by providing dedicated order-taking personnel, the cashier/counter person may be reallocated during peak demand periods to the production or delivery areas in order to accommodate the increase in production. The remote order taking agent 12a may also be trained to cross sell or up sell, e.g. to offer the customer suggestions for ordering additional or alternative menu items, according to order traffic for example, thus increasing revenue. As a result, both order accuracy and speed is increased resulting in improved customer satisfaction while further increasing production and revenue.

According to one embodiment, the various components of the remote order processing system 1 utilize general purpose hardware, such as a personal computer, and therefore easily allow modifications via software upgrades. As a result, the disclosed system 1 is significantly less expensive to both purchase and maintain since relatively low priced general purpose hardware components, such as personal computer boxes, memory, hard drives, processors, mother boards etc. are readily available. Additionally, the hardware may include an adaptive echo canceller, a noise processor, filters and/or speech recognition technology to improve audio quality and further facilitate efficient order taking.

The store 58, 60 further includes an RPOS system 30. As used herein, the terms “point of sale” and “store” are used in a broad sense, and are meant to include any retail environment. According to one embodiment, store 58, 60 includes restaurants, such as full-service restaurants, “fast food” restaurants, drive-through restaurants, delivery type restaurants or any other commercial business that prepares food. The RPOS system 30 further includes one or more POS locations 70, such as drive-through order point(s) or counter-based POS terminals, such as cash registers, etc., and a POS server 90. In one embodiment, the RPOS system 30 may further include the system interface 80. The system interface 80 communicates POS information 250 with the POS server 90. The POS server 90 may maintain store information as discussed above. That store information may be transmitted to the system interface 80. In an alternate embodiment, the system interface 80 and the POS server 90 may be the same device. The system interface 80 communicates with an order distributor 40 and/or the remote agent terminal(s) 42 at the order taking point 24 and optionally with other stores 60 via one or more audio links 81 and one or more data links 82 over the wide area network (“WAN”) 22, as will be described using connectionless networking protocols rather than circuit switched connections, e.g. plain old telephone service (“POTS”).

In on embodiment, the system interface 80 detects a customer presence signal/customer arrival alert corresponding with an arrival of a customer at a remote POS location 70 and in response sends a session request to the order distributor 40 via the network 22. The order distributor 40 sends session information, such as destination information, to the system interface 80 and in response the system interface 80 establishes at least one of: an audio link and/or a data link between the point of sale location 70 and an order taking point 24. According to one embodiment, the system interface 80 routes a call to the order taking point 24, and further, to a remote agent terminal 42 at the order taking point 24.

The system interface 80 may receive a customer presence signal and, in response thereto, the order distributor 40 may establish a session between the customer and an order taker over the WAN 22. The audio link is established so the order taker can receive the customer's order and enter the order into the remote agent terminal 42 and the data link is established so the order taker can transmit the customer's order from the remote agent terminal 42 back to the store 58, 60. In one embodiment, the audio link may be a data link and the audio and data are transmitted over a single connection. WAN 22 may be a wired network, the Internet, a private network, a wireless network such as a cellular telephone network, an 802.11, 802.16, 802.20, WiMax network or any suitable network, or combinations thereof, suitable to implement the connectionless protocols disclosed herein.

As was described above, the plurality of order taking points 24 are further coupled with at least one order distributor 40 and remote agent terminal(s) 42, such as via a wide area network 110, remote from the store(s) 58, 60. The remote agent terminal(s) 42 may include remote order taking agents 12a located in one or more call centers and/or working from their homes (i.e. work at home agents). The plurality of order taking points 24 may include both remote agent terminals 42 consolidated in one or more call centers and/or remote agent terminals 42 which may be distributed in any suitable area such as within a building, a city, county, state, country or anywhere in the world. The order distributor 40 identifies and selects an appropriate remote agent terminal 42 (order taker) for a particular store 58, 60 as discussed above. The remote agent terminals 42 are connected with a customer and receive an order from the customer over an audio and/or data connection.

According to one embodiment, multiple order distributors 40 and/or remote order centers (“ROC”) and multiple remote agent terminals 42 are networked together, such as via WAN 110, so as to function as a distributed virtual call center. In one embodiment, the individual remote agent terminals 42 need not be networked with each other, rather they are networked to at least one order distributor 40. One or more of the ROC's may include an order distributor 40 and may function as a central call center. The order distributor 40 selects remote agent terminals 42 to receive orders received from customers at a store 58, 60. The order distributor 40 may include a router, an automatic call distributor (“ACD”), a switch, a computer programmed to distribute orders or any other suitable device to distribute orders. The order distributor 40 and the system interface 80 may be one or more suitably programmed microprocessors, microcontrollers, digital signal processors (“DSP”), or other processing circuitry, a PC, workstation, server, or any suitable combination of hardware, software, or firmware, and may include associated memory, such as memory 254, 256 respectively that contains a suitable lookup table, database and/or executable instructions that, when executed perform the functions described.

According to one embodiment, the order distributor 40 includes a distributed processor system operating as one or more network elements in the system 1. For example, one or more network elements are provided and interconnected to execute a collection of software applications (application suites) to provide the functionality of the order distributor 40. This concept is also referred to as “virtual call processing.” Multiple network elements, such as multiple servers, each execute the collection of software applications to perform virtual call processing. The multiple network elements provide redundancy so that in the event of a failure of one of the network elements, the remaining operating network elements may continue to provide the virtual call processing functionality of the order distributor 40. The network elements may operate anywhere in the network and are not necessarily located in an ROC or in a same location. The collective operation of these network elements performs the functions of, among other things, selecting the appropriate agent and directing the communication between the appropriate RPOS system 30 and the remote agent terminal 42. It will be appreciated that various logical and physical arrangements of the various network elements are possible and depend upon the implementation of such elements, and that all such arrangements are contemplated herein.

The system interface 80 may further include an audio processor 100, as was shown in FIG. 3. The audio processor 100 receives drive-through microphone audio 84 and provides drive-through speaker audio 86 to/from the drive-through order points 70. The audio processor 100 may perform electronic signal processing, adaptive or otherwise, on drive-through microphone audio received from the drive-through order points in order to improve sound quality and/or implement speech-to-text/text-to-speech conversion for subsequent electronic processing. Electronic signal processing includes echo canceling, noise canceling, gain control, volume control, filtering, such as frequency filtering (e.g. high pass, low pass or band pass), adjustment of other audio parameters and/or performing speech recognition, or combinations thereof on the received audio signal. In one embodiment, the audio processor 100 may use voice recognition to determine the language or dialect of a customer. This language/dialect information is then used in selecting an order taker or remote agent terminal 42 to speak with the customer. For example, the determined language/dialect of the customer may be communicated to the order distributor 40 and utilized by the order distributor 40 to select an appropriate remote agent terminal 42, such as based on stored profiles for each of the remote agent terminals 42. In one embodiment, the electronic signal processing of the received audio is performed prior to converting that audio for transmission via VoIP. In another embodiment, the electronic signal processing performed by the audio processor 100 may be controlled by the remote order taking agent 12a, such as via a client interface available on their remote agent terminal 42. The client interface may communicate with the audio processor 100 via the session connection established with the remote agent terminal 42 as discussed above. This allows the agent 12a to respond in real time to audio quality problems to enhance the audio and complete the transaction. For example, if the customer is unable to hear the agent 12a, the agent 12a can raise the volume of the speaker at the speaker post 2, 4. Alternatively, this audio processing may be automatically performed, such as via automatic/dynamic attenuation of the audio parameters based on sensed audio input levels. The remote agent terminal 42 may further provide audio processing capability to adjust the audio parameters/quality of the agent's 12a headset and microphone. Such adjustments may be manual or automatic in response to sensed audio input levels. In one embodiment, the sensed audio input levels at the speaker post 2, 4 may be used to attenuate the agent's 12a microphone so as to improve audio quality.

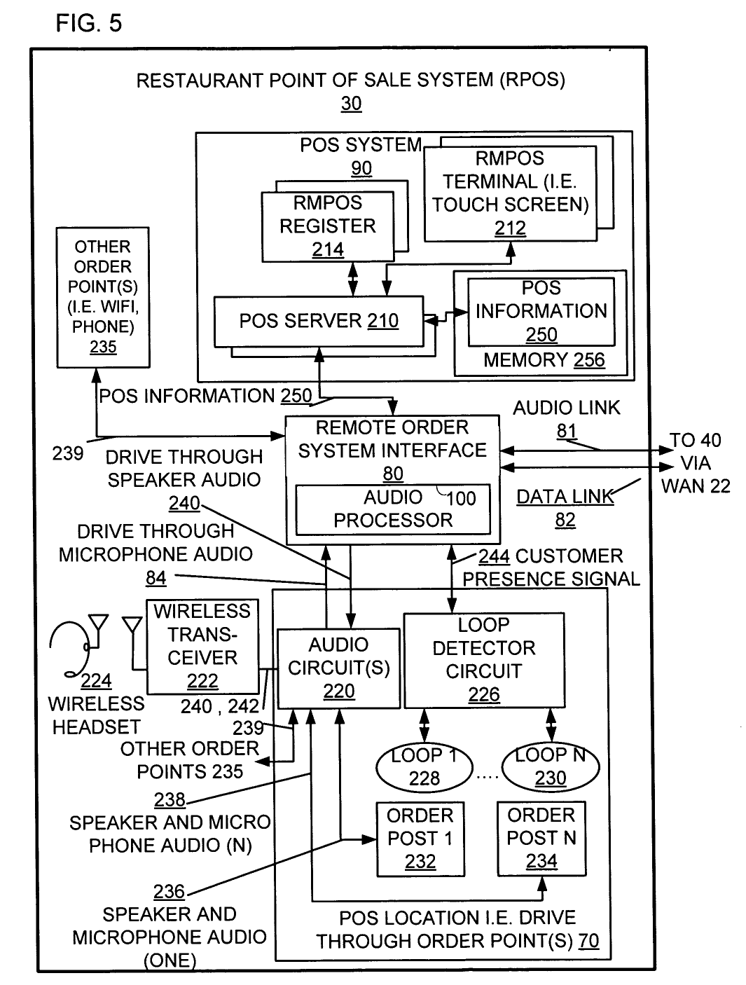

FIG. 5 shows a more detailed block diagram of the RPOS system 30 shown in FIG. 3 according to one embodiment. The RPOS system 30 is located generally at the point of sale where the customer is located and places their order as discussed above, i.e. in the store 58, 60. The RPOS system 30 includes a POS system 90 which further includes a POS server 210, one or more RPOS terminals (i.e. touch screen) 212, 214 or any devices suitable for taking orders which are located at the POS locations 70, such as the counters or drive through lanes. The RPOS system 30 is the customer-store interface by which a customer places an order, either through a POS terminal 212, 214, actuated by an order taker face to face with the customer or the customer themselves, or through an audio connection with an order taker. The one or more drive-through POS locations 70 further include audio circuit(s) 220 such as amplifier(s), a wireless transceiver and antenna 222 suitable for communication with a wired or wireless headset 224, a loop detector circuit 226, one or more loops one-N 228, 230 and one or more order posts one-N 232, 234. Each order post (labeled 1-N) 232, 234 communicates via a speaker and microphone audio 236 with the audio circuit 220. The audio circuit 220 may also communicate speaker and microphone audio 239 either directly or via the system interface 80 with other order points 235 such as wireless (WiFi) order points, phones, kiosks or other suitable order points. The audio processor 100 provides drive-through speaker audio 240 to the audio circuit 220 and receives drive-through microphone audio 84 from the audio circuit 220. The loop detector circuit 226 provides the customer presence signal 244/customer arrival alert to the system interface 80, as was described above.

The headset 224 allows an order taker/cashier to communicate via the wireless transceiver 222 in the case of a wireless headset 224, with anyone in the system 1, such as the customer at the order posts 232, 234, a customer service agent, an administrator, a supervisor or a performance monitor in the order distributor 40 and/or the remote agent terminal(s) 42. In one embodiment, a customer located at the order post 232 at a drive-through is connected via the wireless transceiver 222 with an order taker in failure situations when communications with the order taking points 24 is not possible. The wireless headset 224 and wireless transceiver 222 may be a wireless drive-thru audio system such as one manufactured by HM Electronics, Inc. of Poway, CA 92064. Alternatively, the headset 224 and wireless transceiver 222 may be any wired or wireless headset, cordless phone, Bluetooth interface, cellular telephone, 802.11/802.16 interface or any suitable communication device.

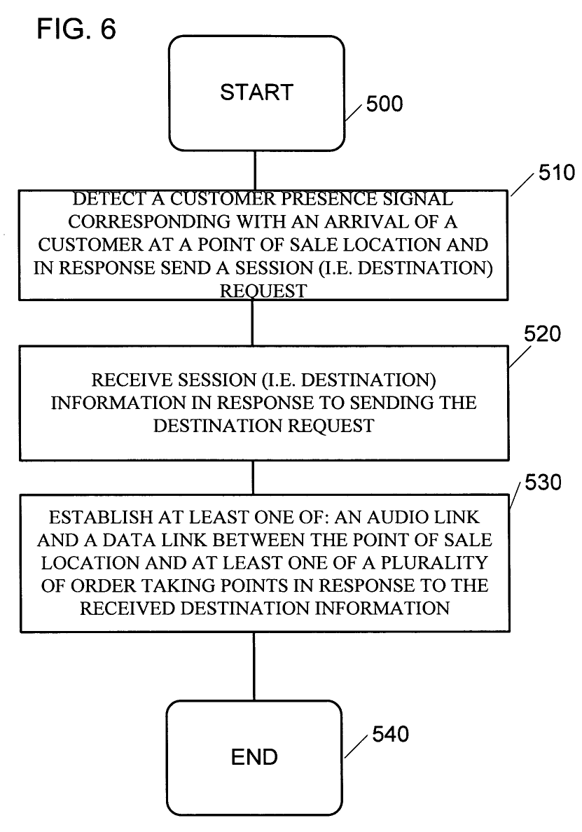

FIG. 6 is a flow chart of an order processing method according to one embodiment. The methods will be described with respect to FIGS. 3 through 5, but are not limited thereto. The methods may be carried out by the system interface 80, the audio processor 100 and/or one or more remote agent terminals 42. However, any other suitable structure may also be used. It will be recognized that the method will be described as a series of operations, but the operations may be performed in any suitable order, and one operation may further include one or more sub-operations.

As shown in block 510, the loop detector circuit 226 provides a customer presence signal 244 to the system interface 80 in response to, for example, a customer in an automobile driving over a customer presence detector such as one of the magnetic loops 228, 230 at a particular point of sale location i.e. drive-through order point 70. In response to detecting the customer presence signal 244, the system interface 80 sends a session request, also referred to as a destination request 246, or the customer presence signal 244, to the order distributor 40, for example, to obtain session information, such as destination information 248, also referred to as a session confirmation, and establish and/or initiate a call with the remote agent terminal(s) 42. In response to receiving the destination request 246, the order distributor 40 selects a remote agent terminal 42 to speak with the customer and receive the customer's order. The destination request 246 or customer presence signal 244 sent to the order distributor 40 may further include store information or point of sale information 250 corresponding with the point of sale location 70, e.g. identifying the location, geographically or otherwise. The destination request 246 or customer presence signal 244 sent to the order distributor 40 may further include connection information, and/or connectionless session information. The point of sale information 250 may further include store information such as any combination of: menu information, store type information, store location information, product outage information, drive-through queue(s) information, drive-through type information, customer language information, kitchen queue information, promotion information, level of service information, and/or projected traffic information. Although the POS information 250 is shown in the POS server 90, the POS information 250 may be generated and/or stored in the system interface 80 or any suitable device external to the POS server 90.

As shown in block 520 and described above, the system interface 80 receives a session confirmation including destination information 248 from the order distributor 40 in response to sending the destination request 246. According to one embodiment, in generating the session confirmation and destination information 248, the order distributor 40 determines an appropriate order taking point 24, the destination information 248 including identification of the selected order taking point 24 (not shown). In an alternative embodiment, the system interface 80 selects the order taker, or the selection thereof is accomplished via the combined processes of the system interface 80 and order distributor 40. In one embodiment, the order distributor 40 selects an order taking point 24, or a remote agent terminal 42, and sends an identifier thereof, as the destination information 248, to the system interface 80, the selection being based on, for example, agent availability information 44. Alternatively, the system interface 80 may send point of sale information 250 related to the point of sale location 70 or store 58, 60 to the order distributor 40. The order distributor 40 may then select the most appropriate remote agent terminal 42 in response to the point of sale information 250, the agent availability information 44, or combinations thereof, similar to the order distributor 40, discussed above in relation to the embodiments of FIGS. 1 and 2. Similarly, where the system interface 80 performs the selection, the order distributor 40 may send agent availability information to the system interface 80 to select an appropriate remote agent terminal 42.

According to one embodiment, the system interface 80 may efficiently receive, manage and distribute orders from the various remote POS locations 70 from the one or more stores 58, 60 and, in response thereto, allocate the orders to the remote agent terminals 42. For a customer at a restaurant who would like to place an order, the restaurant transmits the relevant information to the system interface 80. As discussed above, the system interface 80 and/or the order distributor 40 selects an order taker or remote agent terminal 42 to receive the customer order. The communication from the restaurant to the system interface 80 may contain relevant information about the restaurant including current conditions of the restaurant, i.e., static data, or dynamic data as discussed above. The relevant information may include destination information 248 or store information.

For example, wherein the order processing device performs the selection, the destination information 248 may include information related to remote agent terminals 42 distributed at various locations and/or centrally located at one or more remote order centers. Additionally, the destination information 248 may include a list of available agents, a selected agent and/or ROC queue information 252, described in more detail below, or any suitable combination. The system interface 80 may then select a suitable agent from the received list of remote agent terminals 42 included in the destination information 248, for example by selecting a next available remote agent terminal 42. Any suitable algorithm for selecting an agent may be utilized such as longest idle or next available. Additionally, in response to the point of sale information 250, the system interface 80 may select a remote agent terminal from a plurality of candidate order taking points, as was discussed above in relation to the order distributor 40 of the embodiments of FIGS. 1 and 2.

In one embodiment, the system interface 80 may select an agent in response to the destination information 248 and/or any other suitable information. For example, the system interface 80 may select an agent in response to the list of candidate order taking points, remote agent terminals 42, remote order taking agents 12a and/or the point of sale information. The system interface 80 may also efficiently manage and load balance order traffic amongst the productions lines and adapt to changes in orders. As a result, the remote order system 50 reduces the time for order intake, increases production, reduces customer queues and increases customer satisfaction.

According to another embodiment, the destination information 248 includes information relating to the ROC such as real time and/or projected ROC queue information 252 and/or agent information such as agent availability information 44 and/or agent capability information. As discussed above, the destination information 248 may also be referred to as store information. The ROC queue information 252 may further include hold time information. The ROC queue information 252 may indicate the queue size for each of the remote agent terminal(s) 42 individually, and/or collectively as a group of remote agent terminal(s) 42 such as a remote order call center or node. For example, if the system interface 80 determines that the ROC queue information 252 indicates a large queue size for one or more of the remote agent terminals 42 and/or in response to the received agent information such as agent availability information 44, then the system interface 80 may route the call to a particular remote agent terminal 42 at a remote order center, at a work at home agent, or alternatively to a local agent terminal 214 within the RPOS system 30. The ROC queue information 252 may be either based on the current state of one or more remote agent terminals 42 or based on real time measurements, or projected state information based on a predicted or forecasted traffic levels.

According to another embodiment, the order distributor 40 may probe the system interface 80 for suitable updated and/or additional POS information 250. For example, the destination information 248 may include a request, or any suitable query, for updated and/or additional POS information 250 from the system interface 80 and/or RPOS system 30. As discussed above, store information may be static or dynamic. Static data does not typically change, but if it is updated, the updated static data must be updated within the appropriate components of the system. If the system interface 80 sent old and/or only a subset of the available point of sale information 250 to the order distributor 40, then the order distributor 40 may request updated and/or additional POS information 250 in order to select a suitable remote agent terminal 42 or a group of remote agent terminals 42. According to one embodiment, the order distributor 40 will receive dynamic data with each order, but will only receive the static data if it is new or has been updated. Alternatively, the order distributor 40 periodically requests point of sale information 250 from the system interface 80. In response to this request, the system interface 80 sends the point of sale information 250 to the order distributor 40. The system interface 80 sends the point of sale information 250 to the order distributor 40 either with or without human intervention. For example, the order distributor 40 may update a database server such as a PostgreSQL server or any suitable server. PostgreSQL is a well known open source database.

Referring back to FIG. 5, in one embodiment, the system interface 80 establishes at least one of: an audio link 81 and/or a data link 82 between the POS location 70 and at least one of a plurality of order taking points 24 in response to the received destination information (block 530). The audio link 81 between the customer and the order taking agent allows the agent to receive the customer's order. The order may then be transmitted via the data link 82 from the remote agent terminal 42 back to the store or restaurant 58, 60 for fulfillment of the order. In one embodiment as discussed above, the audio link 81 may be a data link 82 and therefore, the audio link 81 and the data link 82 are the same, i.e. customer and order agent's spoken words may travel as data and the data entered by the agent is also transmitted across the same connection.

The audio link and the data link connect the remote POS location 70 and the order taking point, such as via a network 22 by communicating information formatted as packets having their source and destination addresses, e.g. IP addresses, as the addresses of the remote POS location 70 and order taking point. The audio link 81 and the data link 82 may be established and/or routed via a packet switched network, a circuit switched network suitably configured to carry the packets, a VoIP (voice over internet protocol) or any suitable network, or combinations thereof. Since the information is communicated between an identified source and destination, different portions of an information stream, such as the various packets may take different physical routes, i.e. the link may be a connectionless or virtual link such that the communication information may take different physical routes to facilitate a session. According to one embodiment, multiple remote order centers and remote agents, located in the call center and/or located elsewhere, may be networked together so as to function as a virtual call center. In an alternate embodiment, remote agents may each be independently networked to the point of sale location, store, or restaurant.

According to one embodiment, the system interface 80 establishes the data link 82 and the audio link 81 substantially simultaneously. The data link 82 and the audio link 81 may be established by a packet switched network using, for example, the VoIP (voice over internet protocol). As a result, a telephone application programming interface (TAPI) may be unnecessary. For example, the system interface 80 may establish a call between the customer and one of at least two order taking points 24 in response to detecting the customer loop presence signal 244. As part of the call, the system interface 80 causes a prompt to the selected order taking agent, via their remote agent terminal 42, such as a tone or message, indicating the arrival of a customer. As discussed, the system interface 80 may initiate a connection for at least one of: the audio link 81 and the data link 82 between the POS location 70 and the order taking point 24/remote agent terminal 42 in response to the received destination information 248. However, in an alternate embodiment, the order distributor 40 or remote agent terminal 42 may also initiate the connection.

According to one embodiment, the order distributor 40 selects an appropriate order taking point 24/remote agent terminal 42, e.g. directs one of the order taking points 24 to handle an order according to the selection information as discussed above. For example, the order distributor 40 may select from any one of a number of remote order taking agents 12a in a call center within one of the ROCs or from any of a plurality of remote agent terminals 42. Alternatively, order distributor 40 may select an independent remote order taking agent 12a working from home, rather than an agent located at a remote order center or call center. The order distributor 40 may select an order taking agent at an order taking point 24 based on any suitable agent-availability algorithms, such as longest available agent, next available agent, and maximum available agents or any other suitable algorithm. Further, the agent selection algorithms at the order distributor 40 may also implement various load balancing algorithms such as minimum expected delay, minimum queue length, least busy agent and highest rated agent or any other suitable algorithm.

According to one embodiment, the audio link 81 and/or the data link 82 are established between the point of sale location 70 via an intermediate point, such as the order distributor 40 or any suitable network element, and the order taking point 24. For example, the system interface 80 may build a connection to the intermediate point in response to receiving, for example, destination information 248 from the intermediate point and/or order distributor 40. Accordingly, the intermediate point, such as the order distributor may then establish a link(s) to the order taking point 24. As previously discussed, the audio link 81 and/or the data link 82 may be established between the point of sale location 70 and the order taking point 24 directly without an intermediate point. In other words, the audio or data connection established between the customer and the order taking agent may be established directly, or may be routed through an intermediate component. The intermediate component may be the system interface 80 or the order distributor 40.

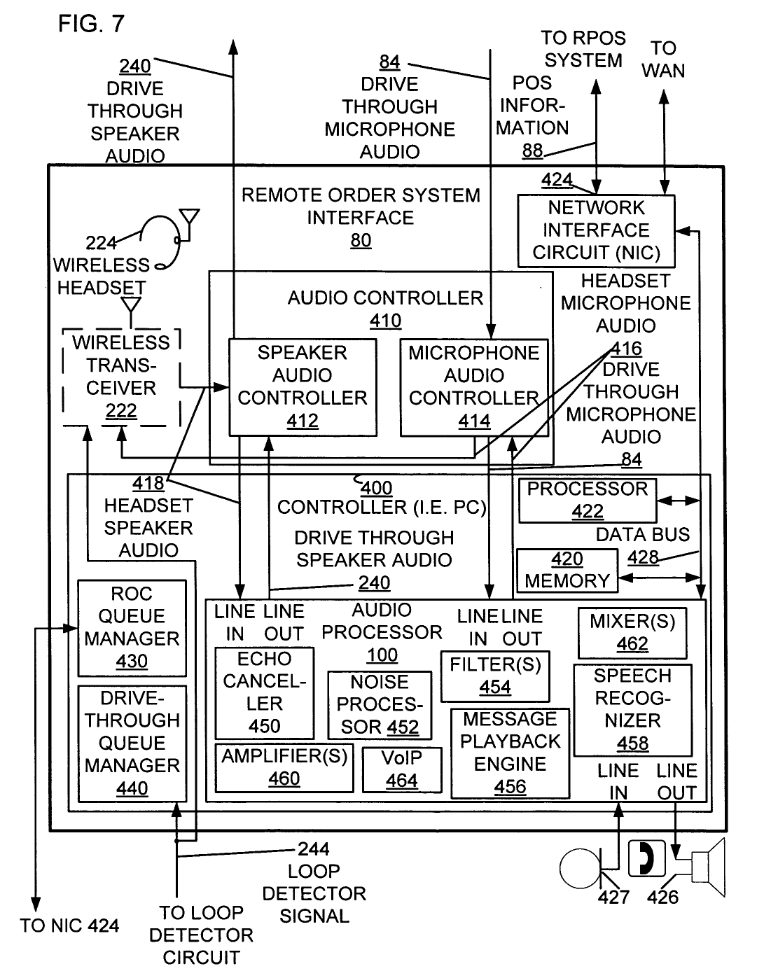

FIG. 7 shows a block diagram of the system interface 80 according to one embodiment. As discussed above, the system interface 80 may act as an interface between the point of sale location 70 (store 58, 60) and the order taking location, i.e. order taking point 24. The customer's presence at a restaurant or at a remote POS location 70 may trigger an arrival alert or presence signal sent to the system interface 80, as discussed. The system interface 80 may then communicate with an order distributor 40 to select an appropriate order taking agent. The system interface 80 includes a controller 400, such as a personal computer (PC), an audio controller 410, memory 420 and network interface circuit 424. In one embodiment where the data and audio are communicated via the same media, the system interface 80 may proxy or otherwise centrally route the communications, i.e. the controller 400 communicates audio and control data 82 with the order distributor 40 and/or the remote agent terminal(s) 42 as shown via, for example, the ROC queue manager 430 and/or the network interface circuit 424. For example, the audio processor 100 may communicate audio data with order distributor 40 and/or the remote agent terminal(s) 42 via VoIP 464 as is known in the art. As opposed to an embodiment in which the remote agent terminal 42 and the POS location 70 communicate directly, this centralized embodiment may permit recording of the order taking sessions, such as for quality control purposes. The controller 400 may also facilitate communication with a circuit switched telephone network and/or a packet switched network. The telephone network may interface with the audio processor 100 via line-in 427 and line-out 426 and/or VoIP 464 as is known in the art.

The audio controller 410 includes a speaker audio controller 412 and a microphone audio controller 414. The controller 400 further includes the audio processor 100, a processor 422, speaker 426, a microphone 427, an ROC queue manager 430 and a customer presence detector 440. The audio processor 100, the controller 400, the processor 422, the ROC queue manager 430 and the customer presence detector 440 may be one or more suitably programmed microprocessors, microcontrollers, DSPs (digital signal processors), or other processing circuitry, a PC, workstation, or any suitable combination of hardware, software, or firmware, and may include associated memory, such as memory 420, that contains a suitable lookup table and/or executable instructions that, when executed perform the functions described. According to one embodiment, the processor 422 is a host processor such as an Intel Pentium microprocessor and the audio processor 100 is co-processor such as a suitable PC audio card.

Speaker audio controller 412 and microphone audio controller 414 may be one or more transistor based switches, mechanical switches and/or relays, time slot interchange devices, software switches or any suitable type of switches. Speaker audio controller 412 may therefore select either drive-through speaker audio 240 from the audio processor 100, or the headset speaker audio 418 from the wireless transceiver 222 and provide the selected audio to the order post 232, 234 (as drive through speaker audio 240). Similarly, the microphone audio controller 414 routes the drive-through microphone audio 84 from the order post 232, 234 to either the headset microphone audio 416 of the headset 224 or to the drive-through microphone audio 84 of audio processor 100 as shown in FIG. 5.

According to one embodiment, the speaker audio controller 412 and the microphone audio controller 414 default to the headset 224 such that if a failure occurs, for example, in the system interface 80, in the order distributor 40 and/or the remote agent terminal(s) 42, then an order taker at the store 58, 60 may take orders via the headset 224. For example, the speaker audio controller 412 and the microphone audio controller 414 may be relays wired so that if the power fails to the system interface 80 and thus to the relays, then the headset 224 will be connected and operational. This may be referred to as the fail safe mode. The audio processor 100 may also provide audio signals to speaker 426 and receive audio signals from microphone 427 located, for example, within the store to play messages, pages or any suitable audio.

Attenuators, impedance matching circuits and/or amplifiers may be included in the audio paths as necessary to match audio input and output levels. For example, an attenuator may be included in the speaker audio controller 412 to attenuate the headset speaker audio 418 and thus attenuate the speaker level audio to the line input of the audio processor 100.

The present embodiments may be provided as a computer program product which may include a machine-readable medium, such as memory 254, 256, 420, having stored thereon instructions which may be used to program a computer (or other electronic devices) to perform a process according to the functions described herein. The machine-readable medium, such as memory 254, 256, 420, may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present embodiments may also be downloaded as a computer program product, wherein the program may be transferred from a remote computer (e.g., a server) to a requesting computer (e.g., a client) by way of data signals embodied in a network or carrier wave or other propagation medium via a communication link (e.g., a modem or network connection) such as WAN 22. Accordingly, herein, a carrier wave shall be regarded as comprising the machine-readable medium.

According to one embodiment, software applications stored in the memory 254, 256, 420, and executed on processors, within the order distributor 40, the system interface 80, perform the functions of the order distributor 40 and system interface 80 respectively. These software application may be installed, upgraded, modified and configured as is known in the art. For example, a new or revised software application may be provided by a computer or memory storage device coupled to the WAN 22. The network interface circuit 424 may then forward the new or revised software application to the memory 420 via data bus 428 for storage.

The optional audio processor 100, which may include hardware, software or a combination thereof, may be used to perform various functions on the audio that is communicated between the customer and the remote order taking agent 12a as discussed above. The audio processor 100 may perform electronic signal processing on drive-through microphone audio received from the drive-through POS locations 70 in order to improve sound quality and/or implement speech-to-text/text-to-speech conversion for subsequent electronic processing. Such processing of the audio may be automated or manually controlled by the remote order taking agent 12a to improve acoustic fidelity in real time. Electronic signal processing may include volume or level adjustments, filtering, frequency enhancement, echo canceling, noise canceling and/or performing speech recognition on the received audio signal. The audio processing may make the audio connection between the customer and the order taking agent more clear allowing for better comprehension. This may alleviate current problems with drive through speakers in which a customer has difficulty hearing and understanding the words from the order taker because the sound quality is poor. In the case of VoIP, the audio processor 100 may implement Quality of Service (“QoS”) protocols to ensure clear and artifact free communications. Such protocols may be further used in conjunction with the fail over mechanisms such that low audio quality, such as due to packet delay or dropped packets, is treated as a failure situation and handled as described herein just like complete communication failures.

In one embodiment, the audio processor 100 may include hardware and/or software which implements an echo canceller 450, a noise processor 452, filter(s) 454, a message playback engine 456, a speech recognizer 458, amplifier(s) 460, mixer 462, VoIP engine 464, or combinations thereof. According to one embodiment, the audio processor 100 may perform electronic signal processing on the drive-through microphone audio 84 received from the drive-through order points 70, as well as drive through speaker audio 240 to perform functions such as echo canceling, noise canceling and/or speech recognition on the received audio signal. Further, the audio processor 100 may compensate for degradation in the components of the communication system, such as degradation of the outdoor speaker due to exposure to the surrounding environment, e.g. weather. In one embodiment, the audio processor 100 features a training or self-calibration function, described in more detail below, which can be used to establish baseline parameters related to the ambient environmental noise, equipment condition or other factors.

The echo canceller 450 may adapt to different levels of echo delay. For example, the order taker's voice may be reflected off the customer's car door and back into the microphone/speaker of the drive-through order post 232, 234 resulting in a delayed version of the order taker's voice heard in the order taker's listening device (i.e. headset). Since the size and distance of the car body and/or door and thus the amplitude and time delay of the echo varies, dynamic echo cancellation may be performed to adapt to the changes in echo. According to one embodiment, dynamic echo cancellation may be performed to compensate for a time delay of 75 ms or 250 ms, however the time delay may range from 500 ms or 750 ms typically. As a result, the echo canceller 450 may be required to compensate for delays of 0 to 1000 ms or any suitable time delay. According to one embodiment, the echo canceller 450 may analyze the tail of an echo signal and dynamically tune and optimize for minimum echo.

According to one embodiment, echo cancellation parameters may be determined in advance for a particular remote POS location 70 and thus is fixed with a particular set of characteristics. For example, the time delay and coupling between the speaker and microphone may be within a relatively small range for a particular POS location 70. Therefore echo cancellation may be identified for a particular POS location 70 and may be static or dynamic within a predetermined range. The time delay echo for a previous order may be recorded in order to identify a starting point for a future call.

The noise processor 452 and/or or filter(s) 454 cleanse the audio background noise and further improve the quality and/or intelligibility of the drive-through microphone audio 84 and drive through speaker audio 240. According to one embodiment, the speech recognizer 458 and the noise processor 452 identify the portions of the drive-through microphone audio 84 that represent human speech and the portions that represent noise. The noise processor 452 then subtracts the noise. For example, the speech recognizer 458 receives an audio signal corresponding to an utterance by the customer (as drive-through microphone audio 84) in response to outputting the at least one prompt. The utterance may represent a customer order or inquiry. The speech recognizer 458 may then associate a probability of human speech with the utterance. The remaining audio energy may be considered noise and removed from the drive-through microphone audio 84. For example, the speech recognizer 458 may employ any speech enhancement algorithm such as those described in: Y. Ephraim and D. Malah, “Speech enhancement using a minimum mean square error log-spectral amplitude estimator,” IEEE Trans. on Acoust., Speech, Signal Processing, vol. ASSP-33, pp. 443-445, April 1985; Y. Ephraim and D. Malah, “Speech enhancement using a minimum mean square error short-time spectral amplitude estimator,” IEEE Trans. on Acoust., Speech, Signal Processing, vol. ASSP-32, pp. 1109-1121, December 1984; Y. Ephraim, D. Malah, and B.-H. Juang, “On the application of hidden Markov models for enhancing noisy speech,” IEEE Trans. Acoust. Speech, Signal Processing, vol. ASSP-37, pp. 1846-1856, December 1989; and other related articles. According to one embodiment, the noise, echo and/or signal cleansing may be implemented in software and/or hardware, such as ClearSpeech® software produced by Noise Cancellation Technologies (NCT) of Cambridge UK and Westport Conn. USA, executed on a digital signal processor

In one example, if the drive-through order point(s) 70 is near a high traffic area such as an expressway, the noise may be characterized as predetermined sounds made by vehicles traveling along a road or an expressway. Accordingly, the noise processor 452 and or filter(s) 454 may identify the type of noise and appropriately subtract the noise from the drive-through microphone audio 84. The subtraction of the background noise results in a better audio connection between the customer and the order taking agent. According to one embodiment, the noise processor 452 and/or filter(s) 454 represent instructions of a computer program executing on a processor 422 such as a microprocessor based computer or digital signal processor. Alternatively, the noise processor 452 and or filter(s) 454 may be built in hardware, firmware and/or software or any suitable combination.

According to one embodiment, the noise processor 452 and or filter(s) 454 may execute a configuration, alignment and/or training routine after initial installation or during periodic intervals to identify the common noise signals present in the drive-through microphone audio 84. For example, since the hands free speaker and microphone at the drive-through order point(s) 70 are outdoors and exposed to the elements, they are subjected to temperature extremes of heat and cold, wind, sun and other natural or manmade elements. As a result, the equipment typically degrades depending on the severity of the environment resulting in degraded drive-through microphone audio 84 and drive-through speaker audio 240. The degradations may result in distortion, reduced amplitude, reduced frequency response and further susceptibility to noise. As a result, manufactures often recommend replacing drive-through order posts about every three years. As the drive-through microphone audio 84 and drive-through speaker audio 240 gradually or suddenly degrade, the echo canceller 450, processor 452 and or filter(s) 454 may periodically compensate for degradations that occur over the life cycle of the equipment. For example, degradations of the microphone and speaker may result in changes in or additional resonant frequencies. Therefore, filtering of signals in these resonant frequencies may reduce noise and increase intelligibility. It is important for the customer to be able to hear the order taking agent as well as for the customer to be confident that the order taking agent properly hears and receives the customer's order. Where the remote order taking agent 12a may control the audio processor 100, the agent 12a can respond in real time to degradation in the audio quality to adjust the audio processor 100.

According to one embodiment, if someone arrives at a drive through POS location 70/speaker post 24 after the restaurant has closed, message playback engine 456 may playback a standard message, such as “thank you for visiting, we are now closed” or other message stored in the memory 420. Alternatively, the message playback engine 456 may play an intelligent/custom message and direct the session to be established accordingly so as to, for example, have a remote order taking agent 12a take the order but pass that order to a near-by restaurant that is still open wherein the customer merely drives to other restaurant to pick and pay for the order. For example, a store manager can program the message playback engine 456 to respond “We are closed. The closest restaurant affiliate open to you is . . . ” Further, the system interface 80 may automatically set up the order taking session with next closest restaurant affiliate.

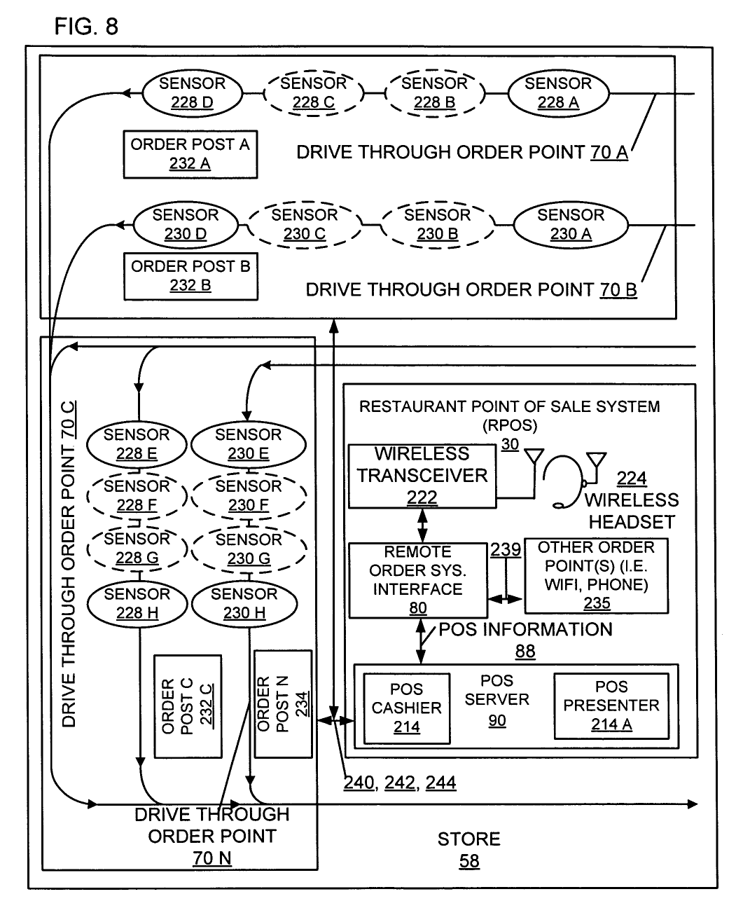

FIG. 8 is a block diagram of an exemplary store 58 with a multi-tandem configuration type drive through according to one embodiment. The store 58 includes multiple drive-through lanes to improve efficiency. FIG. 8 is similar to the block diagram of FIG. 5 except that FIG. 8 has multiple drive through order lanes 70A, 70B, 70C, 70N. Further, one or more sensors 228, 230 are provided for each lane 70A, 70B, 70C, 70N so as to detect not only the customers present at the speaker posts 2, 4 but also determine how many customers are waiting behind the customers presently being serviced. Such sensors 228, 230 may include visual sensors such as a laser or camera, multiple loop detectors or a trip-device, such as a loop detector or other sensor 228D, 228H, 230D, 230 H which detects a customer present and the speaker post 232 and a sensor 228A, 228E, 230A, 230E which counts customer entering the lanes 70A, 70B, 70C, 70N behind the customer being presently serviced in the particular lane. Alternatively, optional sensors 228B, 228C, 228F, 228G, 230B, 230C, 230F, 230G may be provided to directly detect waiting customers, for example, to determine if the line has stalled, such as due to an inattentive customer who has not realized that the customer(s) in front of them has advanced. Alternatively, the queue depth of customers waiting may be inferred based on short and/or long term historical data known about the store's activity in addition to other factors such as the time of day, etc., e.g. an estimate of the queue depth of a particular drive through POS location 70 may be determined based on the probability of there being a queue. Such an implementation may useful for stores which do not have, or cannot implement, multiple sensors for direct queue determination. Further, speaker posts 232A, 232B, 232C are provided for each lane. POS system 90 further includes POS presenter 214A, described in more detail below.

According to one embodiment, the ROC queue manager 430 and the drive-through queue manager 440 monitor the queues in the drive-through POS locations 70 and provide this information to the remote order taking agents 12a in order to provide a better customer experience and a higher level of customer satisfaction. For example, if there are cars at the delivery window 214 but no cars queued up behind, then the remote order taking agent 12a may dynamically offer the customer additional menu items or may otherwise assist the customer in completing their order and further increase revenue. However, if several cars are waiting to place orders, then entering the customer's order as quickly as possible is desirable in order to reduce the drive-through queue size quickly. Since orders may typically last approximately twenty to thirty seconds in duration, additional offerings typically increase the duration of the interaction another five to ten seconds thus increasing the average interaction time about 15% to 30%. As a result, when the drive-through POS locations 70 have a wait, it may be preferable to not make additional offerings to the customer. Reducing the average interaction time can reduce the drive-through queue size quickly.

Further, since call traffic typically fluctuates during the day according to the peak times of breakfast, lunch and dinner, these peak time periods provide information with regard to the appropriate target interaction time for remote order taking agents 12a to achieve. Therefore, with respect to the number of order taker agents available at any given time; the amount of traffic may be accommodated based on the interaction time available for each interaction. For example, as the staffing level of the order taking agents fluctuates during the day, short term spikes in traffic may be accommodated by varying the average interaction time. Spikes in traffic may also occur for other reasons such as the occurrence of a show or sporting event for example. In yet another example, people often think of food when they drive by and see a car in a drive-through. In response to thinking of food, they themselves enter the drive-through causing increased order traffic. Providing information regarding the available average interaction time to the order takers in the system during these peak times permits each order taker to handle the call appropriately. As a result, the order taker workforce may be dynamically managed in accordance with order traffic levels among other considerations, such as the relevant store information discussed above.

According to one embodiment, the ROC queue manager 430 receives ROC queue size or wait time feedback information from the order distributor 40 and/or the remote agent terminal(s) 42. For example, if the order distributor 40 and/or the remote agent terminal(s) 42 has a queue, and if a car arrives at a drive-through order point 70A, 70B, 70C, 70N then in parallel with adding the customer to the queue in the order distributor 40, the message playback engine 456 may play a message to the customer, for example alerting them to the delay and possibly providing an indication of the expected wait time. Since the order queue at the order distributor 40 and/or the remote agent terminal(s) 42 may subsequently be eliminated in a matter of seconds, a brief message may be played such as a greeting or a new/special menu item message may be played thus reducing the agent talk time and effectively spreading out the order traffic until the order distributor 40 queue is empty. When an order taking agent becomes available, the customer will be connected to that agent. As a result, the customer is provided an introductory prompt right away and subsequently does not experience a substantial delay in receiving an acknowledgment from the store of the customer's presence because the customer hears the brief message and then is connected to an available order taking agent. Without the message, the customer would arrive at the drive-through and have to wait for a period of time before hearing anything from the store. The message serves as a transition for the customer, so the customer doesn't feel as though he/she had to wait to place an order. The controller 400/interface 80 may therefore automatically perform a number of activities such as play a message or indicate if making an offer is suitable based on: a) the size of the ROC queue length, b) the size of the drive-through queue, c) traffic levels in the drive-through queue, d) the level of customer experience desired and/or e) the projected or expected traffic, or any suitable combination.

According to one embodiment, a single system interface 80 may receive orders from multiple drive-through order points 70A, 70B, 70C, 70N. Rather than require a separate controller for each drive-through order point 70A, 70B, 70C, 70N, a single system interface 80 may receive and coordinate orders from the multiple order points 70A, 70B, 70C, 70N. For example, if two cars arrive simultaneously or approximately within a relatively short period of time at two different order points in a tandem drive-through 70A, 70B, 70C, 70N, then the system interface 80 may service either car first depending on certain conditions. For example, if a queue is forming or a third car is expected, the back car may be serviced first so that the third car may be more quickly serviced, thus serving all three cars in the least amount of time.

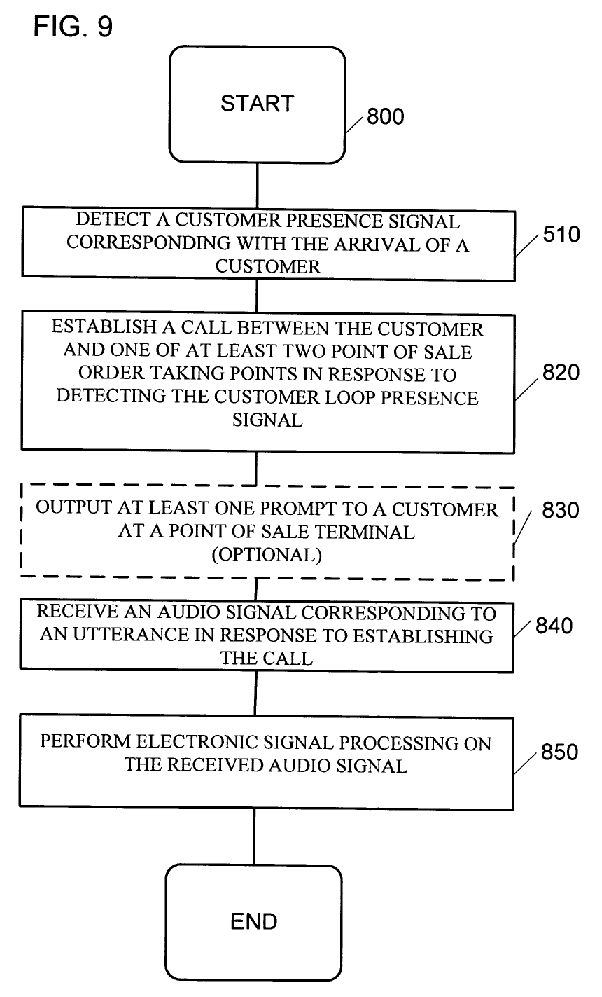

FIG. 9 shows a flow chart of a method beginning with block 800 for electronic signal processing of audio signals according to one embodiment. As shown in block 820, in response to detecting the customer presence signal 244, the system interface 80 may establish a call between the customer at a POS location 70 and one of at least two order taking points 24. The connection will include an audio component for the customer to tell the order taker what he/she would like to order.

As shown in optional block 830, the system interface 80 and/or the selected remote order taking agent 12a may output at least one prompt to a customer at the point of sale terminal 232, 234. For example, a prompt, such as “hello, may I take your order?” may automatically be generated without human intervention by the system interface 80 using, for example, speech synthesis. This may be implemented as discussed above, as a message from the message playback engine 456. Alternatively, the prompt may be generated by the remote order taking agent 12a. Rather, than a recording, the agent 12a may say “hello, may I take your order?” These prompts, whether automatically or manually generated, may be contextualized based on time of day, time of year and/or geographic regions and associated dialect. For example, in southern states, the greeting prompt may be “Good morning y'all” as opposed to “good morning” in northern states. During the winter holidays, the prompt may include “happy holidays.” Prompts may also be adjusted to announce daily specials or to promote certain products and may be time-of-day based, such as to promote breakfast products in the morning and dinner products in the evening. Where the prompts are provided by the remote order taking agent 12a, the agent 12a may be automatically prompted by their remote agent terminal 42 to ensure that a proper prompt is provided, for example, in cases where the agent 12a is located in a substantially different time zone than the customer.

As shown in block 840 the system interface 80 receives an audio signal corresponding to an utterance by the customer (as drive-through microphone audio 84) in response to establishing the call and/or outputting the at least one prompt. For example, the utterance may represent a customer order or inquiry. The utterance is the words spoken in the communications between the customer and the order taking agent.

As shown in block 850, the system interface 80 may perform electronic signal processing on the drive-through microphone audio 84 received from the drive-through order points 70. For example, the system interface 80 may improve the quality and/or intelligibility of the drive-through microphone audio 84 as is described in more detail below with regards to FIG. 5. Additionally, the system interface 80 may utilize speech recognition to automate recognition of the order or to merely identify the presence of human speech.

According to one embodiment, quality control tools for performance analysis and management of the remote order system 50 may provide information relating to the performance of the store 58, order distributor 40 and/or the remote agent terminal(s) 42 and/or the order taking points 24 or any suitable system element. This information is referred to above as store information or destination information. This store information is used in a variety of ways, such as in the selection of an order taking agent. For example, the order distributor 40 and/or the system interface 80 may collect information related to the store 58, order distributor 40 and/or an order taker. The following is exemplary information that may be collected and may be included in the store information that is transmitted from the store to the interface 80, database 10, order distributor 40, or remote order taking agent 12a:

(a) Average speed of answer;

(b) Average talk time (i.e., hold time);

(c) Total number of calls answered;

(d) Number of orders taken and associated revenue;

(e) Revenue generated from offerings;

(f) Product/store outage information;

(g) Trending of the various data points;

(h) Correlation/analysis of revenue of generation with associated store activity (product outages, weather conditions, events);

(i) Reporting of store actual vs. store goals;

(j) Accuracy of order; and

(k) Quality scores.

In addition, the system 1 may log complete order taking interactions, including the data exchange and audio exchange so as to be able to replay the interaction at a later time for analysis, training or other purposes.

It is understood that the implementation of other variations and modifications of the present disclosure in its various aspects will be apparent to those of ordinary skill in the art and that the invention is not limited by the specific embodiments described. It is therefore contemplated to cover by the present disclosure any and all modifications, variations or equivalents that fall within the spirit and scope of the basic underlying principles disclosed and claimed herein.

We claim:

1. A method of receiving a first order for an item from a first patron with respect to a first establishment at which the first patron is located and at which the ordered item is to be delivered to the first patron, the method comprising:
(a) receiving, at a central location, a first indication of a need to receive the first order;
(b) selecting, at the central location in response to the first indication, a first remote location, from a plurality of remote locations, at which to receive the first order, the first remote location being geographically remote from at least one other of the plurality of remote locations and from the central location;
(c) at the first remote location, displaying first information relating to a first set of items available at the first establishment;
(d) receiving the first order at the first remote location; and
(e) while the first order is being received at the first remote location, providing information about the first order electronically from the first remote location to an order processing system that performs order entry and/or order processing functions at the first establishment.

2. The method of claim 1, wherein the item comprises a food item, the first establishment comprises a first restaurant and the first information displayed at the first remote location further comprises information relating to a first set of food items available at the first restaurant.

3. The method of claim 1, further comprising:
(f) determining whether the central location has performed the selecting; and
(g) receiving, at a backup central location when the central location is determined not to have performed the selecting, the indication; and
(h) selecting, at the backup central location in response to the first indication, the first remote location, from the plurality of remote locations, at which to receive the first order.

4. The method of claim 1, wherein the receiving of the first order further comprises receiving the first order at the first remote location from the first patron independent of the central location.

5. The method of claim 1 wherein the providing further comprises providing the information about the first order to the order processing system independent of the central location.

6. The method of claim 1, wherein the displaying further comprises displaying information relating to at least one business constraint of the first establishment.

7. The method of claim 6, wherein the business constraint comprises operating hours of the first establishment.

8. The method of claim 6, wherein the business constraint comprises an up-sell.

9. The method of claim 6, wherein the business constraint comprises a cross-sell

10. The method of claim 6, wherein the business constraint comprises a promotion offered by the first establishment.

11. The method of claim 1 wherein the selecting further comprises determining that each of the plurality of remote locations are unable to receive the first order, and in response thereto, identifying an additional remote location which may receive the first order, sending a request to the additional remote location to determine if the additional remote location is able to receive the first order and selecting the additional remote location to receive the first order upon confirmation that the additional remote location is able to receive the first order, the method further comprising:
(f) at the first remote location, displaying the first information relating to the first set of items available at the first establishment;
(g) receiving the first order at the additional remote location; and
(h) while the first order is being received at the additional remote location, providing information about the first order electronically from the additional remote location to an order processing system that performs order entry and/or order processing functions at the first establishment.

12. The method of claim 1 further comprising:
(f) receiving, at a central location, a second indication of a need to receive a second order for an item from a second patron with respect to a second establishment at which the second patron is located and at which the ordered item is to be delivered to the second patron;
(g) selecting, at the central location in response to the second indication, the first remote location at which to receive the second order;
(h) at the first remote location, displaying second information relating to second set of items available at the second establishment, the second set of items being different than the first set of items, the displaying further comprising normalizing the second information with the first information prior to displaying the second information;
(i) receiving the second order at the first remote location; and
(j) while the second order is being received at the first remote location, providing information about the second order electronically from the second remote location to an order processing system that performs order entry and/or order processing functions at the second establishment.

13. The method of claim 12, further comprising providing the first and second information to the first remote location prior to receiving the first and second indications.

14. The method of claim 1 further comprising:
(f) receiving, at a central location, a second indication of a need to receive a second order for an item from a second patron with respect to a second establishment at which the second patron is located and at which the ordered item is to be delivered to the second patron;
(g) selecting, at the central location in response to the second indication, a second remote location, from a plurality of remote locations, at which to receive the second order, the second remote location being geographically remote from at least one other of the plurality of remote locations and from the central location;
(h) at the second remote location, displaying information relating to a second set of items available at the second establishment;
(i) receiving the second order at the second remote location; and
(j) while the second order is being received at the second remote location, providing information about the second order electronically from the second remote location to an order processing system that performs order entry and/or order processing functions at the second establishment.

15. The method of claim 14, wherein the second order is received essentially simultaneously with the first order.

16. The method of claim 1 wherein the first order is received telephonically.

17. The method of claim 1 wherein the first remote location comprises a home of an order taker.

18. The method of claim 1 wherein the displaying first information further comprises initiating the reception of the first order from the first remote location.

19. The method of claim 1 wherein each of the plurality of remote locations comprises a facility, the first remote location comprising a facility geographically remote from the facility of at least one other of the plurality of remote locations.

20. A method for receiving an order for an item from a patron with respect to a establishment at which the patron is located and at which the ordered item is to be delivered to the patron, the method comprising:
(a) at a home of an order taker, displaying information relating to a set of items available at the establishment;
(b) receiving the order by the order taker at their home; and
(c) while the order is being received by the order taker, providing information about the order electronically from the home to an order processing system that performs order entry and/or order processing functions at the establishment.

21. A method for receiving an order for an item from a patron with respect to a establishment at which the patron is located and at which the ordered item is to be delivered to the patron, the method comprising:
(a) displaying, remote from a call center, information relating to a set of items available at the establishment;
(b) receiving the order remotely from the call center; and
(c) while the order is being received remote from the call center, providing information about the order electronically to an order processing system that performs order entry and/or order processing functions at the establishment.

22. A method comprising
receiving a first order for a restaurant food item from a first patron with respect to a first restaurant at which the first patron is located and at which the ordered restaurant food item is to be delivered to the first patron, and
balancing the load of the ordering process by
(a) receiving, at a central location, an indication of a need to receive the first order;
(b) selecting, at the central location in response to the indication, a first remote location, from a plurality of remote locations, at which to receive the first order, the first remote location being geographically remote from at least one other of the plurality of remote locations and from the central location;
(c) receiving the first order at the first remote location;
(d) at the first remote location, displaying information relating to a set of food items available at the first restaurant, and
(e) while the first order is being received at the first remote location, providing information about the first order electronically from the first remote location to an order processing system that performs order entry and/or order processing functions at the first restaurant.

23. The method of claim 22 further comprising:
receiving a second order for a restaurant food item from a second patron with respect to a second restaurant at which the second patron is located and at which the ordered restaurant food item is to be delivered to the second patron, and
wherein the balancing further comprises:
(f) receiving, at a central location, an indication of a need to receive the second order;
(g) selecting, at the central location in response to the indication, a second remote location, from a plurality of remote locations, at which to receive the second order, the second remote location being geographically remote from at least one other of the plurality of remote locations and from the central location;
(h) receiving the second order at the second remote location;
(i) at the second remote location, displaying information relating to a set of food items available at the second restaurant, and
(j) while the second order is being received at the second remote location, providing information about the second order electronically from the second remote location to an order processing system that performs order entry and/or order processing functions at the second restaurant.

24. The method of claim 23, wherein the second order is received essentially simultaneously with the first order.

25. The method of claim 22 wherein the first order is received telephonically.

26. The method of claim 22 wherein the first remote location comprises a home of an order taker.

27. The method of claim 22 wherein the receiving of the first order further comprises initiating the reception of the first order from the first remote location.

28. The method of claim 22 wherein each of the plurality of remote locations comprises a facility, the first remote location comprising a facility geographically remote from the facility of at least one other of the plurality of remote locations.

29. A method comprising
receiving an order for a restaurant food item from a first patron with respect to a first restaurant at which the first patron is located and at which the ordered restaurant food item is to be delivered to the first patron, and
balancing the load of the ordering process by
(a) receiving the order at a home of an order taker;
(b) at the home, displaying information relating to a set of food items available at the first restaurant, and
(c) while the order is being received at the home, providing information about the order electronically from the home to an order processing system that performs order entry and/or order processing functions at the first restaurant.

30. A method comprising
receiving an order for a restaurant food item from a first patron with respect to a first restaurant at which the first patron is located and at which the ordered restaurant food item is to be delivered to the first patron, and
balancing the load of the ordering process by
(a) receiving the order remotely from a call center;
(b) displaying, remote from the call center, information relating to a set of food items available at the first restaurant, and
(c) while the order is being received remote from the call center, providing information about the order electronically to an order processing system that performs order entry and/or order processing functions at the first restaurant.

31. A method comprising
receiving essentially simultaneously orders for restaurant food items from two or more different patrons with respect to two or more different restaurants at which the patrons are located and at which ordered food items are to be delivered to the respective patrons, and
balancing the load of the ordering process by
(a) receiving, at a central location, an indication of a need to receive the orders;
(b) selecting, at the central location in response to the indication, a first remote location from a plurality of remote locations, at which to receive the order from the one patron, and a second remote location from the plurality of remote locations, at which to receive the order from the other patron, the first and second remote locations being geographically remote from at least one other of the plurality of remote locations and from the central location;
(a) receiving the orders telephonically at the first and second remote locations,
(b) at the first remote location, displaying information relating to a set of food items available at the one restaurant,
(c) at the second remote location, displaying information for use in connection with another one of the orders associated with another one of the restaurants, the information relating to a set of food items available at the other restaurant, and
(d) while the orders are being received at the first and second remote locations, providing information about the orders electronically from the first and second remote locations to an order processing system that performs order entry and/or order processing functions at the one restaurant and the other restaurant.

32. A method comprising
receiving essentially simultaneously orders for restaurant food items from two or more different patrons with respect to two or more different restaurants at which the patrons are located and at which ordered food items are to be delivered to the respective patrons, and
balancing the load of the ordering process by
(a) receiving the order from the one patron telephonically at a first home of a first order taker and receiving the order from the other patron telephonically at a second home of a second order taker,
(b) at the first home, displaying information relating to a set of food items available at the one restaurant,
(c) at the second home, displaying information for use in connection with another one of the orders associated with another one of the restaurants, the information relating to a set of food items available at the other restaurant, and
(d) while the orders are being received at the first and second homes, providing information about the orders electronically from the first and second homes to an order processing system that performs order entry and/or order processing functions at the one restaurant and the other restaurant.

33. A method comprising
receiving essentially simultaneously orders for restaurant food items from two or more different patrons with respect to two or more different restaurants at which the patrons are located and at which ordered food items are to be delivered to the respective patrons, and
balancing the load of the ordering process by
(a) receiving the orders telephonically remotely from a call center,
(b) remote from the call center, displaying information relating to a set of food items available at the one restaurant,
(c) remote from the call center, displaying information for use in connection with another one of the orders associated with another one of the restaurants, the information relating to a set of food items available at the other restaurant, and
(d) while the orders are being received remote from the call center, providing information about the orders electronically to an order processing system that performs order entry and/or order processing functions at the one restaurant and the other restaurant.
